(19) United States
(12) Patent Application Publication
(10) Pub. No.: US 2019/0066220 A1
(43) Pub. Date: Feb. 28, 2019

(54) SYSTEMS AND METHODS FOR DISTRIBUTED COMPUTERIZED ASSIGNMENT AND DISPLAY OF TRADE ORDER DATA

(71) Applicant: FIS FINANCIAL SYSTEMS LLC, JACKSONVILLE, FL (US)

(72) Inventors: Anthony Scianna, Atlantic Highlands, NJ (US); Jeffrey Berman, New York, NY (US); Simon Buffler, Hoboken, NJ (US); Kenneth J. Omahen, Chicago, IL (US); Paul Garside, Watertown, MA (US); Alun Daniel Griffith Green, Chicago, IL (US)

(73) Assignee: FIS FINANCIAL SYSTEMS LLC, JACKSONVILLE, FL (US)

(21) Appl. No.: 16/120,190

(22) Filed: Aug. 31, 2018

Related U.S. Application Data
(63) Continuation of application No. 12/905,978, filed on Oct. 15, 2010, now abandoned.
(60) Provisional application No. 61/252,555, filed on Oct. 16, 2009.

(51) Int. Cl. G06Q 40/06; G06Q 40/04

(52) U.S. Cl. CPC G06Q 40/06; G06Q 40/04

(57) ABSTRACT

A system for derivative trade processing aggregates data relating to trades across a plurality of buy side and sell side firms. Requests are received from buy side and sell side firms to search the aggregated data. The system searches the aggregated data provides a listing of trade data for trades between the requesting party and a plurality of counter-parties. The requestor may view all trades and tasks associated with those trades. The requestor may view the trades and tasks in prioritized lists. In response to a request, the system allocates a trade to a plurality of accounts.

### CROSS REFERENCE TO RELATED APPLICATIONS

The present application claims priority to U.S. provisional patent application 61/252,555, filed on Oct. 16, 2009 and titled “Derivative Trade Processing,” the contents of which are hereby incorporated herein by reference in its entirety.

### BACKGROUND

Firms that trade in the derivative marketplace typically maintain trading relationships with a plurality of counter-party firms. For example, a hedge fund firm may have established relationships with a plurality of brokerages with which they trade. Likewise, a brokerage may have relationships with numerous entities such as hedge funds and money managers for which they operate as a broker.

While firms may have numerous trading relationships, each relationship and the communications supporting trading between firms are maintained on a one-to-one basis. Thus, a hedge fund may need to establish trading communications separately with each broker with which they trade. Typically, the hedge fund and the broker use disparate trading platforms and require customized software in order to provide communication between firms. The integration between systems often provides limited functionality which results in many trade-related operations such as, for example, allocation, to be implemented outside the established communication channel.

Furthermore, for a single firm with an established trading relationship with a particular brokerage, activities associated with trades are performed separately and in isolation from trades that the particular firm may have with other brokers. Thus, a hedge fund's trading arrangement and communications with a first brokerage is entirely separate from and independent from the hedge fund's communication with a second brokerage. This is the case, even though, from the perspective of the hedge fund, several trades, each of which is handled by a different broker, may, in fact, be related to a single account of the hedge fund.

Processing of derivative trades, whether listed or non-listed derivatives, is complicated by the lack of sophisticated communications between buy and sell side firms and the lack of support for complex relationships between buy side and sell side firms. For example, the allocation of cleared trades to the appropriate accounts is frequently complicated and subject to human error. Each buy side and sell side firm in a one-to-one trading relationship accesses trade data regarding completed trades through their own system. Trades listed on sell side allocation requests are required to match the allocation trade data of the receiving buy side firm. But it is frequently the case that data in a sell side firm's system does not match the data in the buy side's system. Under existing techniques, resolving mismatches and addressing special circumstances often requires phone calls, and/or amending and resending data. Indeed, for the buy side, allocation instructions are often delivered via telephone, e-mail or fax, with no system to easily check the validity of the trade. On the sell side, allocations are often received and implemented without knowing whether the buy side is referring to the same transaction. The dynamic nature of trades, the independent data silos that exist between each buy and sell side firm, and high trade volume results in a complicated trading process that is readily subject to error.

### SUMMARY

Applicants disclose a trade processing system that aggregates trade data and related data for derivatives across a plurality of buy side firms and sell side firms. The derivatives may be listed and/or unlisted derivatives. The trade processing system is communicatively coupled with a plurality of buy and sell side firms, and receives data regarding the trades requested and implemented by the various parties to a trade. For example, as sell side firms enter requested trades, the data regarding the trade is entered into the trade processing system. Likewise, as sell side firms receive and execute trades, information regarding the trades is received and entered into the trade processing system. The trade processing system is adapted to communicate with buy and sell side systems so as to provide information such as, for example, updates to trade data for trades that originated on the particular system.

The trade processing system receives trade related data from a plurality of buy and sell side firms. Accordingly, the trade processing system may receive requests to provide for any one buy or sell side firm an aggregated view of trade data for all trade counter-parties. For example, the trade processing system may receive a request from a buy side firm such as, for example, a hedge fund, to provide a listing of all trades the buy side firm has requested in a particular length of time such as, for example, for a given trading day. The trade processing system accesses its database of aggregated trade data that it accumulates from the plurality of trading firms and identifies the trades requested by the requesting party across all sell side firms that may be servicing those trade requests. The trade processing system may then transmit or otherwise present to the requesting buy side firm an aggregated listing of the trades the firm has executed across all sell side firms. Similarly, a sell side firm may request and receive information detailing all of the derivative trades that the sell side firm has serviced and/or is servicing across a plurality of buy side firms. The requests and listings provided by trade processing system in response to those requests may reflect the trades themselves and/or the tasks associated with the trades.

Thus, the trade processing system receives and services requests to review trade data from a one-to-many relationship. In other words, the trade processing system will search for and transmit trade data for a single buy or sell side firm across all corresponding counter-party firms. In an exemplary embodiment, the trade processing system can search the aggregated data to provide aggregated numbers regarding all trades and/or corresponding tasks that a particular firm may have. The trade processing system may be programmed to not only provide a listing of trades and/or corresponding tasks for a buy or sell side firm, but to calculate and communicate aggregates such as total trades, total allocations, and total outstanding tasks. Further, the trade processing system provides breakdowns for aggregates. For example the trade processing system specifies for outstanding tasks, the number of tasks that have been completed and the number that have not. Further breakdown of the types of tasks and appropriate actions is presented in a manner which facilitates divisions of duties within an organization. The trade processing system utilizes counterparty relationships to assure authorized processing between parties.

In an exemplary embodiment, the trade processing system may selectively prioritize the presentation of pending trades and/or tasks associated with pending trades. In an exemplary embodiment, the trade processing system comprises rules that specify factors for determining the relative priority of a trade or task associated with a trade relative to other trades or tasks associated with a particular firm. For example, a rule may provide that cleared trades and associated tasks that are unallocated and which correspond to clearing house or an exchange that is scheduled to close within a prescribed period of time, e.g. two hours, are to have a high priority. Similarly, trades and/or tasks for which have a negative open trade equity exist beyond a prescribed amount may be designated high priority. Rules may be predefined by the system but may also be created and/or modified by the firms themselves. For example, a buy or sell side firm may establish a rule for performing auto allocation against data that comes into a particular account for a particular exchange and contract combination. Similarly, a rule may specify an auto-allocation of trades for a particular order once the order has been completely filled. The trade processing system provides counterparties of a trade with access to trade data that originates from other sources. For instance, the trade processing system allows buy and sell side firms to perform an acceptance and/or rejection of give-in claims, and define rules for performing such acceptances, within the trade processing system and without having to take action from an alternate system interface. The prioritization rules are used by the trade processing system to format the presentation of data when it is transmitted to the requesting party.

The trade processing system may also allow buy and sell side firms to perform tasks relative to trades. For example, an exemplary embodiment of the trade processing system allows buy side firms to specify allocation instructions. Moreover, a buy side firm may allocate a completed trade across a plurality of accounts. For example, the trade processing system may transmit for a particular buy side firm a listing of trades that are unallocated. The operator may select a particular trade and request to allocate the trade. The trade processing system provides a user interface that allows the operator to specify an allocation across multiple accounts. Further, the operator may select multiple trades and allocate the results of the trades across multiple accounts. The trade processing system receives allocation information from the operator and updates its database and those of the interfacing systems to reflect the allocation. The allocation data is immediately available to any counter-parties to the allocated trades. As noted previously, the trade processing system allows operators, which may represent, for example, buy and sell side firms, to define rules specifying the implementation of tasks, such as allocations, relative to trades.

The trade processing system maintains a network of connections with firms and organizations that enables the various organizations to request inputs and actions on the part of others and to respond to such requests. In one embodiment, the trade processing system employs communications with firms and organizations to enable buy and sell side firms to manage post trade processing. For example, the trade processing system may facilitate alerts being generated to remind buy and sell side firms of outstanding tasks that require attention. The alerts may alternatively relate to industry news and data that may be of particular interest. The trade processing system may accept rules that define circumstances under which an alert or reminder should be made to a party to a trade. In an exemplary embodiment, a rule may specify that an alert should be generated where a trade remains unallocated less than an hour before the close of the market upon which the trade was executed. Similarly, a rule may specify that an alert be generated when a trade remains unallocated and has a negative open trade equity exceeding a prescribed value. The trade processing system stores such alert criteria in its database and monitors for circumstances when the criteria are met. When the criteria are met, the system generates and transmits an alert to the responsible firms impacted by the criteria. The system also allows for operators of the system to generate alerts outside of those automatically generated based upon rules.

The trade processing system also provides for the creation, management, and aggregation of account data across a variety of systems via processes and interfaces that facilitate data integrity across multiple applications. For example, firms such as fund managers, trading firms, executing brokers, and clearing brokers may enter and verify within the trade processing system information about the various parties that use their systems. Furthermore, the firms may link the various parties in the trade processing system to particular accounts and define the authority of the parties to those accounts. The trade processing system is adapted to verify trade information with the account information and generate alerts where the trade information cannot be verified.

The trade processing system maintains the status of all trades between buy-side and sell-side participants. The system is adapted to provide for full monitoring, auditing, and reporting on trade status and flow, including, for example, activities performed within a supporting business process management tool. The trade processing system supports the “give-up” of trades between executing brokers and clearing brokers. The system tracks and reports statuses between exchanges, clearinghouses and brokers with regard to “give-up” instructions and notifications. The trade processing system also tracks the status of messages between the community, exchanges, and clearing houses. The system maintains information regarding acknowledgements, failures, cancels, corrects, etc., for trade messages between these participants.

The trade processing system allows parties that have accounts on the system to share information and work collaboratively. For example, persons from different firms may collaborate on documents and contracts. Individuals from participating firms may communicate with multiple parties at once. For example, a sell side firm may communicate with the multiple counterparties of a trade simultaneously. The trade processing system may be used to form a social network of derivative trade processing professionals who can readily communicate and collaborate between firms in a secure, compliant environment.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

The foregoing summary and the following additional description of the illustrative embodiments may be better understood when read in conjunction with the appended drawings. It is understood that potential embodiments of the disclosed systems and methods are not limited to those depicted.

FIG. 1 is a network diagram of an illustrative trade processing system.

FIG. 2 is a flow diagram of a process for aggregating buy side and sell side data.

FIG. 3 is a diagram of an illustrative functional system architecture comprised in a trade processing system.

FIG. 4 is a flow diagram of a process for aggregating account data.

FIG. 5 is diagram depicting functional components of a sell side user interface provided by a trade processing system.

FIG. 6 is diagram depicting functional components of a buy side user interface provided by a trade processing system.

FIGS. 7-21 depict illustrative user interface screens created by an illustrative trade processing system.

FIG. 22 depicts an exemplary flow of processing in an illustrative trade processing system.

FIGS. 23-40 depict illustrative user interface screens created by an illustrative trade processing system.

FIG. 41 depicts an exemplary flow of processing in an illustrative trade processing system for a sell side initiated alert for buy side allocation.

FIG. 42 depicts an exemplary flow of processing in trade processing system for a buy side allocation wherein an exception is enforced by the system.

FIG. 43 depicts an illustrative user interface screen created by an illustrative trade processing system.

FIG. 44 is a flow diagram of a process for processing account management data.

FIG. 45 depicts a block diagram of an exemplary computing environment that may be used to implement the systems and methods described herein.

### DETAILED DESCRIPTION OF ILLUSTRATIVE EMBODIMENTS

Exemplary Computing Environment

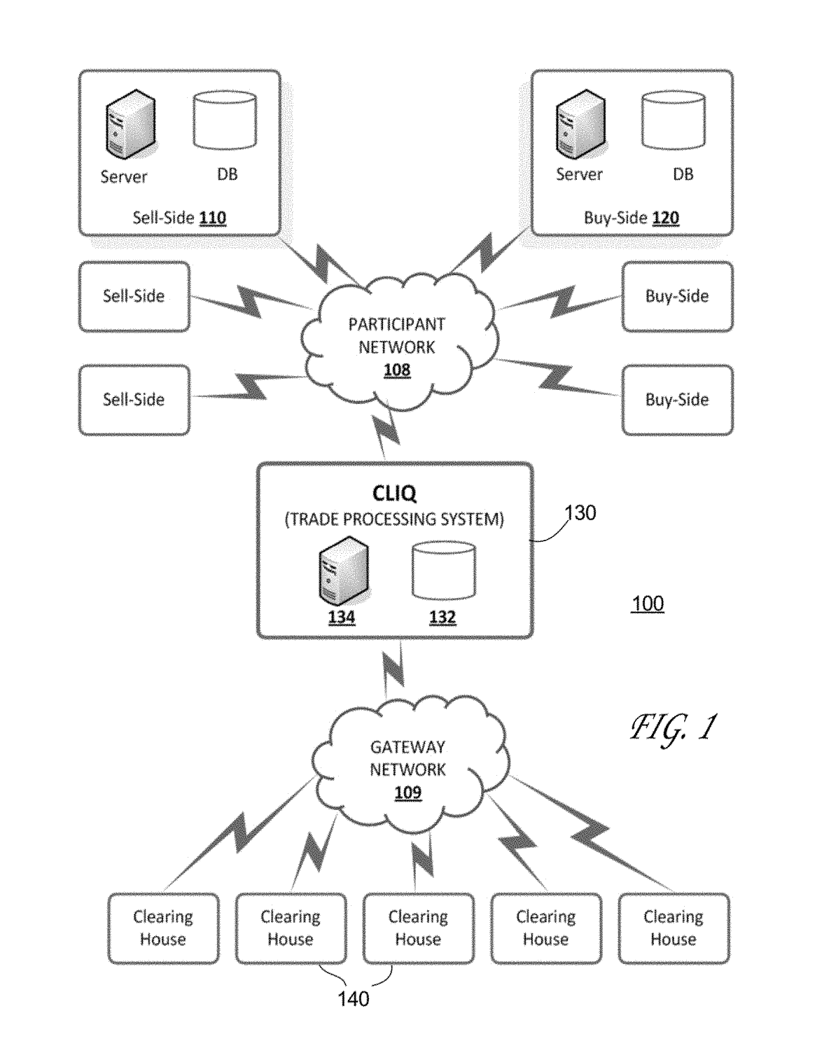

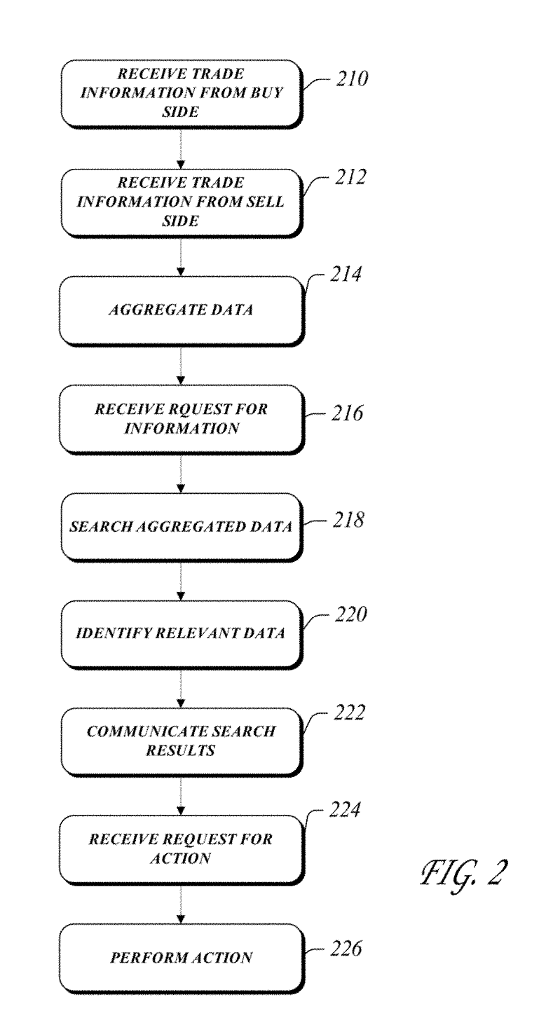

FIG. 1 illustrates an exemplary computing arrangement 100 suitable for implementing derivative trade processing. In computing arrangement 100, a plurality of trading systems 110 are operated by entities that represent the sell side in derivative trade transactions. The derivative trade transactions may be for listed and/or non-listed derivatives. Similarly, a plurality of trading systems 120 are operated by firms that represent the buy side of derivative trades. Both sell side 110 and buy side 120 systems typically comprise databases comprising information regarding trades requested and fulfilled by the party, as well as server computers that provide the computing functionality for implementing trades. Sell side 110 and buy side 120 are communicatively coupled via network 108 with trading clearing houses 140 which may be trade exchanges or have access to exchange data. In an exemplary embodiment, clearing houses 140 are accessed through a network gateway 109. Sell side 110 and buy side 120 systems may receive data relating to current market conditions and trade status from clearing houses 140. Sell side 110 and buy side 120 may also interface with clearing houses 140 to request trades and receive information relating to requested trades.

Sell side 110, buy side 120, and trading clearing houses 140 are communicatively coupled over network 108 and/or network gateway 109 with trade processing system 130. Trade processing system 130 is adapted to receive and aggregate account and trade data from a plurality of sell side systems 110 and buy side systems 120. Trade processing system 130 receives and stores data regarding accounts associated with, and trades implemented by, a plurality of sell side 110 systems. Likewise, trade processing system 130 receives and stores data regarding accounts associated with, and trades requested by, a plurality of buy side systems 120. Thus, for any buy side system 120, trade processing system 130 may comprise information regarding all trades implemented for that particular party across all sell side systems 110. Likewise, for any sell side system 110, trade processing system 110 comprises information regarding all trades requested of the system 110 from all of buy side systems 120.

Operators of sell side systems 110 and buy side systems 120 communicate with trade processing system 130 to access aggregated trade data and to perform functions such as trade allocation relative to those data as described herein.

Trade processing system 130 comprises one or more databases 132. Databases 132 comprise the trade data received from sell side 110 and buy side 120 systems and clearing houses 140, as well as any other data used in processing of the system. For example, databases 132 may comprise data computed by system 130 as well as data relating to users, firm and individual accounts, trade allocation, rule implementation, prioritization of trades and/or tasks, alerts, matching, trade positions, margin positions, billing, reporting, and archiving.

Trade processing system 130 further comprises computing systems 134. Computing systems 134 are programmed with computing instructions for aggregating data from sell side 110 and buy side 120 systems. The computing systems 134 are further programmed with computing instructions in order to provide the functionality as described herein.

Network 108 is adapted to facilitate communication of data between systems 110, 120, 130 and 140 and may be any type of network suitable for the movement of data. For example, network 108 may be, or may comprise all, or a portion of, a local area network (LAN), public switched telephone network, the Internet, or any other network suitable for communicating data. Network 108 may comprise a combination of discrete networks which may use different technologies. For example, network 108 may comprise local area networks (LANs), wide area networks (WAN's), or combinations thereof and may employ any suitable topology including wireless and wireline networks.

Gateway network 109 is adapted to facilitate communications with external systems such as, but not limited to, clearing houses 140. Gateway network may comprise any combination of hardware and/or software that facilitates communication between such systems.

Transaction Data Aggregation

FIG. 2 depicts a flow chart of an illustrative process performed by trade processing system 130 for aggregating and processing derivative trade data. As shown, at step 210, information relating to derivate trades is received for a plurality of buy side firms. For example, in an illustrative embodiment, as trades for buy side firms such as, for example, hedge funds are made, data reflecting the trades is stored in database 132.

At step 212, information relating to derivatives trades is received for a plurality of sell side firms. For example, in an illustrative embodiment, as trades for sell side firms such as brokers are made, data reflecting the trades is stored in database 132. Those skilled the art will appreciate that data relating to derivative trades handled by clearing houses or clearing broker may also be received and stored in database 132 in connection with data aggregation.

At step 214, the derivative trading information is aggregated. Derivative trade processing data is received for each of a plurality of buy side and a plurality of sell side firms. Furthermore, the data is accumulated over time. Thus, database 132 may comprise data reflecting all market trades made by each of a plurality of buy side and sell side firms over a period of time. Aggregating trade data may further comprise matching data received from buy side firms with trades specified in data received from sell side firms. This matching may be performed by any adequate mechanism including for example, matching the trades based on trading number.

At step 216, trade processing system 130 receives a request for trades satisfying particular criteria. For example, the request may comprise search criteria specifying a particular buy side firm, sell side firm, or clearing house, and a particular period of time. In other words, the request may specify parameters of a search for trades associated with a particular firm during a particular period of time. For example, a search request may specify searching for current and/or historical trades made by a particular buy side firm. The search request may also specify a particular counter-party or a series of counter-parties. For example, a search request may specify querying for trades made by a particular buy side firm where a particular sell side firm was the counter-party. The request may further specify retrieving trades for a plurality of different sell side firms.

At step 218, trade processing system 130 searches the aggregated data for trades satisfying the received search criteria. In an exemplary embodiment, this step comprises searching database 132 for the relevant data.

At step 220, trade processing system 130 identifies the relevant trade data corresponding to the search request. In an illustrative embodiment, this step involves receiving the results of a database query and the data related to those search results. In an exemplary scenario, trade processing system 130 may identify trade data corresponding to trades requested by a particular buy side firm. Trade processing system 130 may identify trade data relating to trades requested by a particular buy side firm that were brokered or otherwise handled by one or more of a plurality of sell side firms. In an exemplary embodiment, the data relating to trades may comprise data reflecting outstanding tasks for trades. For example, the data may indicate that particular trades have not been allocated, or that there is an error associated with a trade that needs attention. The data relating to trades may comprise data reflecting current and historical status of trades requested or fulfilled by a particular buy side or sell side firm. In an example scenario, the data relevant to the search results may comprise data indicating trades have been processed by systems residing at one or more of the plurality of sell side firms, a clearing house, or clearing brokers. In another example scenario, in response to a search by a sell side firm requesting trades that were requested by a particular sell side firm, the system identifies a plurality of buy side firms which were associated with the trades.

At step 222, trade processing system 130 communicates the search results including identified data to the requestor. In an illustrative embodiment, the search results may be communicated over a network and/or to a user via a user interface. In one embodiment, the results may be processed before communicating the data to the requestor. For example, the data may be prioritized based upon the values of the data. In a particular embodiment, the information may be prioritized in order to highlight unallocated trades. For example, the unallocated trades may be listed first in a listing of trade data or presented in a particular color. The trade processing system allows the user to control and adjust data represented, and the system by default applies business logic to assist requestor in the absence of any specified logic.

At step 224, trade processing system 130 may receive a request to take action or perform a task with respect to a particular trade. The request may be received from a user of the system such as the recipient of search results, but also may be received and/or performed automatically by the system itself. For example, the request may specify that a particular trade be allocated in a particular manner. In one potential scenario, the request may specify that a trade be allocated across a plurality of accounts with a particular firm. A request may specify that a plurality of trades be allocated to a plurality of accounts established across a plurality of firms. Also, a request may specify that an alert be generated and communicated to a particular person, firm, and/or organization with a firm. The requested alert may communicate any suitable information including, for example, an indication that a trade has not been allocated and effectively request allocation via the trade processing system.

At step 226 trade processing system 130 performs the requested action. For example, trade processing system 130 may allocate a trade as requested or may communicate an alert as requested.

Exemplary Functional Architecture

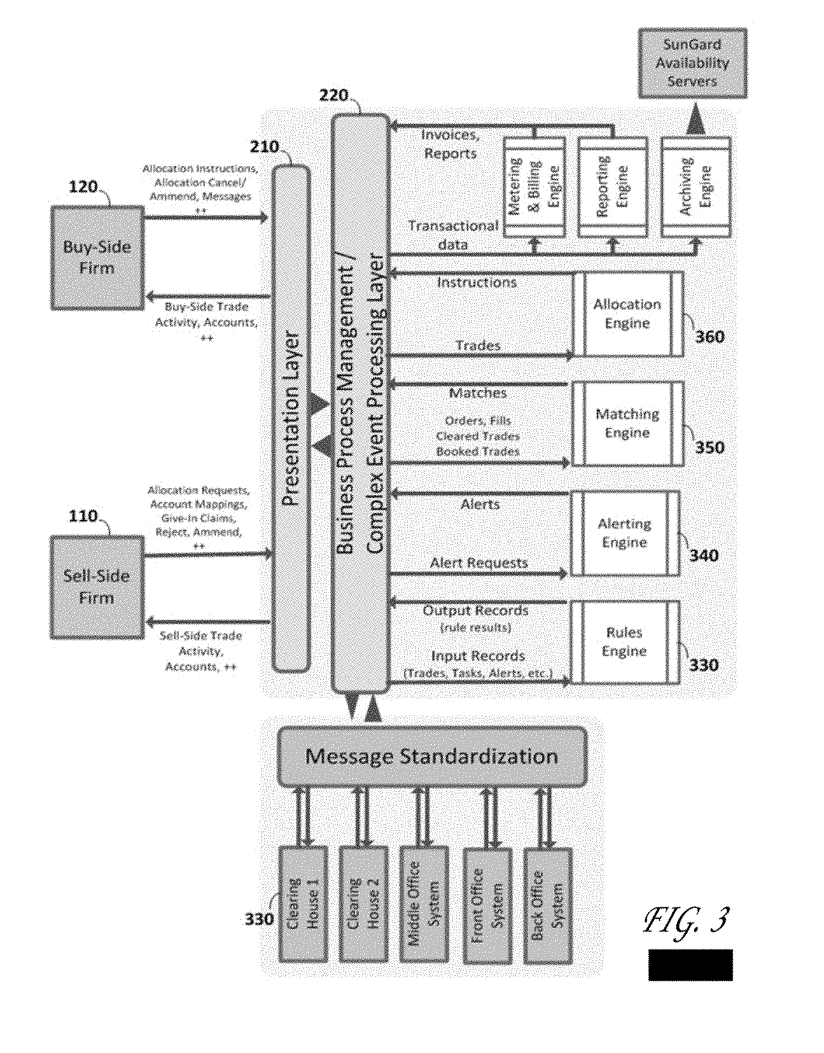

FIG. 3 illustrates a functional computer processing architecture that is implemented via trade processing system 130. As shown, trade processing system 130 comprises interfaces with sell side firms 110 and buy side firms 120 as well as with various exchanges and/or clearing houses 140. Trade processing system 130 is adapted to receive data from sell side firms 110, including, for example, data regarding the trades that are executed by the firms. Likewise, trade processing system 130 receives data from buy side firms 120 including, for example, data regarding requested trades and data regarding allocations specified for completed trades by the buy side. Still further, trade processing system 130 is adapted to receive data from clearing houses 140 including, for example, data regarding executed trades and current market conditions.

Trade processing system 130 provides functionality that is accessible via the buy side 120 and sell side firms 110. This functionality may be accessible via user interfaces, such as mobile user interfaces, that may be provided, for example, via a Web interface and accessed, for example, via the Internet. The interfaces may provide functionality as described herein including, for example, the capability for buy side 120 and sell side firms 110 to view aggregated trade data for all of their trades across all firms. Likewise, buy side firms 120 or sell side firms 110 may allocate implemented trades across various accounts. Information regarding the allocations made by buy side firms 120 or sell side firms 110 is available in real time to both buy and sell side firms that may also be accessing information regarding those same trades. The interface allows sell side firms 110 to, among other things, enter alerts directed to a buy side firm 120 to enter information such as, for example, allocation information.

Trade processing system 130 comprises a presentation layer 310 that manages the user interfaces that are presented to various buy side 120 and sell side firms 110. Presentation layer 310 may create and provide a unique interface to a particular individual at a firm depending upon the role that the particular individual performs at the firm. For example, the presentation layer 310 may generate an interface for an individual at a buy side firm that allows the individual to see all trades requested by the firm and to enter allocation information for all trades. But for another individual associated with the same firm that performs a different role in the organization, the presentation layer 310 may create and present a different interface that allows the individual only to view trade data and not to take any action with respect to the trades.

Trade processing system 130 may further comprise a business process management layer 320. Business process management layer 320 maintains a status for trades between the buy-side and sell-side participants and is adapted to monitor, audit, and report on trade status and flow. The business process management layer 320 implements workflow in the system so as to coordinate the exchanges and inputs made by buy side and sell side parties. For example, business process management layer 320 may, in response to an alert entered at an interface at a sell side firm, communicate an alert to the interface of individuals for the corresponding buy side firm. The logic to the workflow may be implemented by the process management layer 320, while the presentation layer 310 creates and communicates the appropriate information to the correct user interface.

Business process management layer 320 manages and aggregates user and account data. In an exemplary embodiment, business process management layer is adapted to link accounts with relevant data. For example, business management layer 320 is adapted to link an individual or account management group, who may be a beneficial owner or custodian, to a particular account. Furthermore, system operators may link accounts of entities that are trading counter-parties. For example, an account at a buy side firm is linked to an account at a sell side firm. Once accounts are linked, business management layer 320 can compare information from accounts to identify inconsistencies and to alert the appropriate individuals and/or organizations.

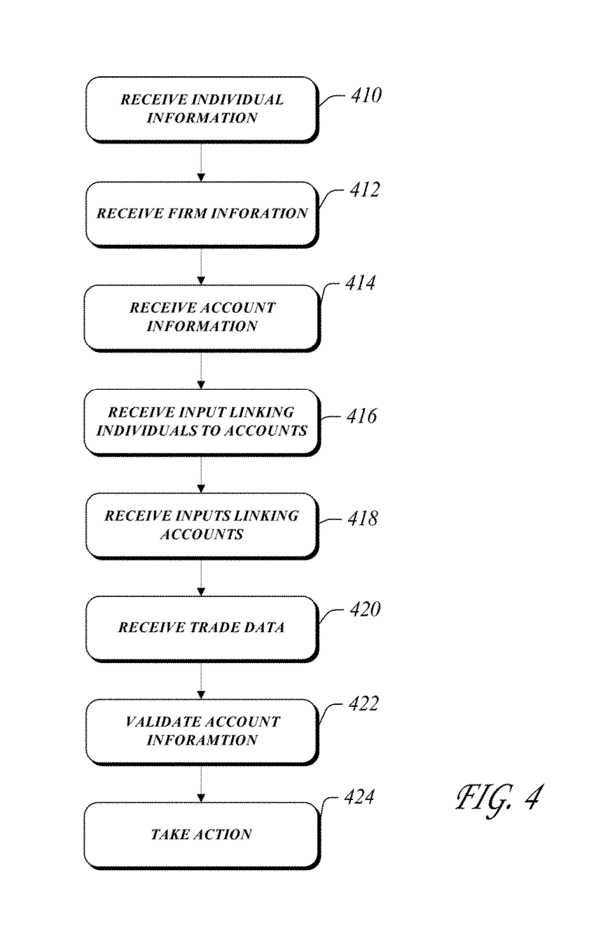

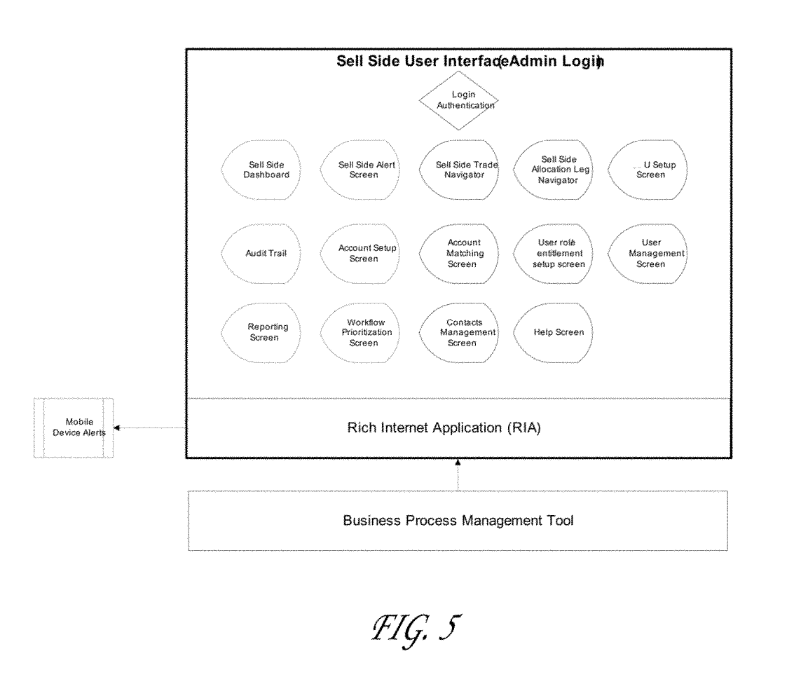

FIG. 4 depicts a flow chart of an illustrative process for aggregating account data. As shown, at step 410, business process layer 320 is adapted to receive information regarding individuals. For example, the information may comprise contact information regarding a person's name, address, phone, and email as well as information regarding the individual's trading activities and accounts. The individuals may be clients of firms that use the transaction processing system, employees of such firms, users of the system, etc. Information about individuals may be stored in any suitable manner, including, for example, in a database such as processing database 132.

At step 412, business process management layer 320 may receive information regarding firms or organizations that participate in or contribute to trading. For example, the information may identify a firm and the type of activities in which the firm engages, i.e., whether the firm is a buy-side firm, a sell-side firm, a clearing house, etc. Information regarding firms may be stored in any suitable manner, including, for example, in a database such as processing database 132.

At step 414, business process management layer 320 receives inputs specifying accounts that are associated with firms. For example, information about an account may include the type of account, e.g, whether it is a trading account, and any limitations or automated rules associated with the account. Information regarding firms may be stored in any suitable manner, including, for example, in a database such as processing database 132.

At step 416, business process management layer 320 receives inputs linking individual users to particular accounts and firms. For example, inputs may be received identifying a particular user or account management group as the owner of an account. Inputs may specify that several users are associated with an account. For example, the account may be a joint account. The inputs might also identify individuals that have particular responsibilities within a firm and with respect to a particular account. For example, the business process management layer 320 may receive inputs specifying an individual as any of the following: a trader which may be an individual with legal authority to exercise discretion over trading decisions by a trading account; an algo controller which may be an individual who supervises or determines the strategy of an automated trading system; a broker which may be an individual who executes trades for a trading account but has no input or discretion over that account or its trades; and a manager which may be an individual acting on behalf of a firm.

At step 418, business process management layer 320 receives inputs linking accounts that have been created in buy-side firms and sell-side firms. For example, a broker account for a particular user on the buy side may be linked to a particular trade account on sell-side. This step may comprise receiving a request from a firm to share information regarding an account with one or more other firms. Business management layer 320 notifies the one or more other firms of the request to share account information. Business process management layer 320 may receive inputs from the firms that received the offer to share account data to receive the account data. In an exemplary scenario, a buy side firm may communicate to the system that it wants to make one or more accounts accessible to one or more sell side firms. One or more of the sell side firms are notified by the system of the offer, and receive or have access via the system to data associated with the account that was offered for share. Finally, the one or more firms that received the request to share account information may use the system to designate a link to one or more of its accounts to the account that has been offered for linking.

At step 420, business process management layer 320 may receive information about executed trades. For example, information regarding executed and/or pending trades may be received from clearing houses 140. The information regarding executed trades may comprise information about the buy-side firm associated with a trade, the sell-side firm associated with the trade, and the particular individuals associated with the accounts including, for example, the owner/user of the account and any broker associated with account.

At step 422, business process management layer 320 is verifies or validates the information received about trades with the information that has been aggregated for accounts. Thus, business process management layer 320 may confirm that the information received about an executed trade is consistent with information stored in the database. In particular, the business process management layer 320 may confirm buy-side firm and the sell-side firm in the information received from the feed are the correctly listed. Likewise, the business process management layer 320 may confirm that the account information listed in the received trade information is consistent with the information in the in the system database.

If the business process management layer 320 determines that a discrepancy exists between the received trade information and the information in the database, i.e, the verification process fails, at step 424, business process management layer 320 may take action in some manner including, for example, designating the particular trade for further review. For example, business process management layer 320 may communicate alerts to the individuals, firms, and/or organizations with a firm that are responsible for the trade. Additionally, the business management layer 320 may automatically take corrective action based on rules established for the firm to auto correct the trade data and send the correction back to the clearing house 140.

In an illustrative scenario, business process management layer 320 may be employed to manage account information relating to a fund management firm. For example, business process management layer 320 may receive inputs defining a buy side firm that is a fund manager, meaning that the firm manages alternative investment funds on behalf of a pool of investors. Business process management layer 320 may receive inputs providing information regarding the beneficial owners of a fund. The information may comprise personal information regarding an individual. Business process management layer 320 may receive inputs from managers at the fund verifying the personal data of the beneficial owners. Managers at a fund manager may also enter inputs linking beneficial owners with particular fund accounts. Business process management layer 320 is further adapted to receive inputs making available to clearing brokers those fund accounts that are cleared by that clearing broker.

In another illustrative scenario, business process management layer 320 may be employed to manage account and trading information relating to a trading firm. For example, business process management layer 320 may receive inputs defining a buy-side firm that is a trading firm meaning that the firm executes trades on a market either directly or via a broker. Business process management layer 320 may receive inputs entering personal data for traders at the firm. Inputs may be received entering personal data for algo controllers at the firm. Still further, inputs may be received entering personal data for beneficial owners of a trading account. Business process management layer 320 may receive inputs from managers at the trading firm verifying the personal data for traders, algo controllers, and beneficial owners. Business process management layer 320 accepts inputs, from managers at a trading firm, for example, linking traders and algo controllers with trading accounts over which they have trading control. Inputs may also be received linking beneficial owners with their trading accounts. Managers at a trading firm may enter inputs making available to executing brokers those trading accounts that are guaranteed by that executing broker. Similarly, managers at a trading firm may enter inputs making available to executing brokers those trading accounts for which the executing broker will execute trades on instruction of the trading firm. Managers at a trading firm may still further enter inputs making available to clearing brokers those trading accounts that are cleared by that clearing broker.

In another illustrative scenario, business process management layer 320 may be employed to manage account and trading information relating to an executing broker. For example, business process management layer 320 may receive inputs defining in the system a sell side firm that operates as an executing broker meaning that the firm originates or guarantees orders on a market. Business process management layer 320 makes available to an executing broker those trading accounts that have been authorized by a trading firm. Managers at an executing broker may link trading accounts made available by client trading firms with executing accounts, which may be referred to as bookkeeping accounts, held at the executing broker for those clients. Business process management layer 320 may receive inputs from managers at an executing broker linking clearing house accounts with executing accounts, e.g., bookkeeping accounts, held at the executing broker. Business process management layer 320 verifies that all accounts on the clearing house feed are mapped to bookkeeping accounts and sends system alerts and produces reports for any accounts that fail such verification.

In another illustrative scenario, business process management lawyer 320 may be employed to manage account and trading information relating to a clearing broker. For example, business process management layer 320 may receive inputs defining in the system a sell side firm that operates as a clearing broker, meaning that the firm holds and maintains positions on a market. Managers at a clearing broker may enter inputs linking give-in references made available by client fund managers with clearing accounts, e.g., bookkeeping accounts, held at the clearing broker for those clients. Business process management layer 320 verifies that all give-in references on the clearing house feed are mapped to bookkeeping accounts and generates system alerts for any accounts that fail such verification. Managers at a clearing broker may designate bookkeeping accounts as either proprietary accounts, which may be owned by the clearing broker or its affiliate, or customer accounts. Managers at a clearing broker may link trading accounts sent by client trading firms or fund accounts sent by client fund managers to bookkeeping accounts held at the clearing broker for those clients. Business process management layer 320 verifies that all bookkeeping accounts are either designated proprietary accounts or are linked with one or more trading accounts or fund accounts, and communicates system alerts, produces reports and provides business workflows to facilitate correction of the condition for any accounts that fail such verification.

In an exemplary embodiment, the business process management layer 320 is adapted to implement exception management. For example, the business process management layer is adapted to recognize an invalid data input from a user or interface and to modify the workflow in response to the error. For example, in the instance where during an allocation workflow a buy side firm inputs an invalid account, the business process management layer 320 identifies that the account is incorrect and changes the workflow to request a corrected input.

Trade processing system 130 comprises a plurality of engines or servers that support the various functionality that is offered by the system. A rules engine 330 is adapted to create, register, classify, manage, control, and implement rules without the need for specialized human intervention. The rules engine 330 uses rules to determine a course of action based upon pre-defined criteria. For example, rules engine 330 may create and implement rules for determining whether to provide a particular individual with access to system functionality, for processing trade data, for prioritization of tasks, and for generation of alerts. According to particular exemplary embodiment, a firm's administrator may define rules that specify for different individuals and/or different roles at the firm the data and functionality that should be displayed to the particular individual or role. The rules are stored in processing systems 132 database. Rules engine 330 accesses the data during execution of the system in order to implement and enforce the rules. For example, rules engine 330 may determine that a rule has been established that specifies trade data should be presented to users of a particular firm using a particular priority. Rules engine 330 coordinates with business process layer 320 and the presentation layer 310 to insure that the desired priority is implemented on screens presented to the particular firm.

Rules engine 330 may be employed to define and enforce essentially any type of logic relating to trade processing. For example, rules engine 330 may be adapted to define and enforce rules for matching trades between different buy and sell side firms. In an exemplary embodiment, rules engine 330 may employ rules to prioritize manual tasks. For instance, rules engine 330 allows for creating and enforcing a rule whereby an unallocated trade awaiting allocation instructions may be prioritized as “high priority” based on a business rule that dictates that trades from clearinghouses that have nearly reached a time limit for allocation, e.g., one hour before market closing, should be categorized as high priority. Rules may be employed to determine ownership of, or responsibility for, particular tasks.

In an exemplary embodiment, rules engine 330 may be employed to create and enforce rules for automatically generating allocation instructions based on trade attributes. For instance, a rule may provide that if a trade is from a particular clearing house, has been executed by a particular executing broker, and is for a particular contract, then a particular set of allocation instructions (e.g., 50 percent to a first account, 50 percent to a second account) may be enforced.

Rules engine 330 may be employed to create and enforce rules for automatically triggering an alert of dynamically determined recipients in response to the occurrence of an external event or a condition being met. For instance, a rule may provide that if a particular clearing house has reached a predetermined time limit for performing allocation, and the clearing house has more than a prescribed number of outstanding trades, then an alert is generated to a list of recipients. The list of recipients may comprise particular individuals. The list of recipients might designate only a firm or organization within a firm and not specify a particular individual. Indeed, in many instances, the specific individual that needs to be alerted is not known but is derived using the condition and metadata in the trade processing system.

Rules engine 330 may be employed to create and enforce rules for assigning trades from clearing houses to particular back office accounts based upon predefined criteria. For instance, a rule may provide that if a trade has a first attribute, e.g, attribute A1=value V1, and second attribute, e.g., A2=value V2, then the trade should be assigned to a particular account.

Trade processing system 130 further comprises an alerting engine or server 340. The alerting engine 340 is adapted to create, update, prioritize, and communicate alerts to organizations and individuals. Senders and receivers of alerts are able to track the actions associated with an alert and access records related to the alert. Alerts may be triggered in response to a wide variety of events including, for example, user actions; system and/or trading events; and satisfaction of conditions of a rule. The alerts may be communicated to a particular individual or individuals, a particular firm or firms, particular organizations or groups within a firm, and/or broadcast to a large audience. The ability of individuals and/or firms to access functionality for generating an alert, and for taking specific actions regarding an alert, is controlled by security entitlements. All actions undertaken against an alert or any of its associated records are recorded in an audit trail. Users who are authorized in the system to see an alert, may also view information identifying who is working in connection with the alert, what actions associated with an alert have been completed, and what actions associated with an alert have not been completed. Information regarding alerts may be stored in, for example, trade processing system database 132.

There are numerous circumstances wherein an alert may be used. In an example embodiment, a clearing firm may create an alert to effect action on data managed within the trade processing system 130. For example, a clearing broker may create a user-generated alert that is communicated to the trading firm in order to alert the trading firm to provide allocation instructions for trades that cannot be cleared due to lack of instruction. The trade processing system 130 communicates the alert to the trading firm along with the records (trades) that require allocation instruction. The trading firm can initiate action upon these trades from within an alert panel and process the trades completely or partially. In an exemplary scenario, a buy side firm may request an alert be sent to an individual, firm, or organization within one or more sell side firms notifying the sell side firm(s) that there is an error associated with a trade. In an exemplary scenario, a sell side firm may request that an alert be sent to an individual, firm, or organization within one or more sell side firm(s) that a trade has been claimed or that a trade has not been given up.

The alerting engine 340 is adapted to manage and make visible all actions undertaken against the relevant records. Actions resulting from other engines, such as the rules engine 330 or the allocation engine 360, are automatically reflected in the status and history of the relevant records and associated alerts. Accordingly, all parties with an interest in the status of alert can view the latest information regarding status. When all actions or milestones that are associated with a particular alert have been completed, the alerting engine 340 closes the alert and retains the audit trail of activity. The alerting engine 340 tracks and maintains an audit of activity on the alert and all subject records referenced in an alert, whether acted upon from within the alerting engine or any of the other service engines.

In an example embodiment, alerting engine 340 may be used to create and communicate event triggered alerts containing industry data such as, for example, new product release data. An industry update alert may be automatically communicated to all parties for which the content is applicable. Alerting engine 340 confirms that the information is received and opened. Should an alert be dismissed in error or confirmation of receipt not received, and the receiving parties have indicated a need to receive this information, the alerting system 340 can reissue the communication. By way of further example, alerting system 340 may be employed to create an industry alert in the event that an exchange calendar is changing outside of a predefined schedule. The alerting engine 340 can distribute this content to all parties that require information regarding the particular exchange. For example, an alert may notify recipients that processing on a particular exchange is running behind schedule and operating hours have been extended.

In an example embodiment, trade processing system 130 and alerting engine 340 may be used to create and communicate a rule triggered alert. For example, a rule may specify that an alert be created when a trade has not been allocated and the exchange on which the trade was executed is scheduled to close in a predetermined period of time. An alert is communicated to the clearing firm and the trading firm in order to highlight the approaching close of the allocation window of the exchange and to prompt action for all open trades on that exchange.

In an example embodiment, trade processing system 130 may be used to create and communicate a broadcast alert to all system participants or to subsets of system participants. A broadcast alert may be used, for example, to communicate critical information that may be of particular interest to the firms and individuals that use the system. Community events, critical utility updates, and other types of information may be communicated using a broadcast alert.

Matching engine 350 compares and matches trade orders to fills. Matching engine 350 determines for each order that has been entered, the one or more fills that correspond to the particular order. The matching engine 350 operates on data that is received from the various buy and sell side firms in order to perform the matching.

Matching engine 350 provides matching of different types of records across the entire trade lifecycle. For example, matching engine 350 provides matching between orders and fills, between fills and cleared trades (i.e., trades from clearing house), and between allocation legs and booked trades. Matching engine 350 is adapted to receive matching criteria that is stored and applied to incoming records. For those matches that cannot be automatically resolved, matching engine 350 presents a user interface to allow for human resolution of the match.

Matching engine 350 provides visibility into the status and lifecycle of a trade from order through to trade booking. All parties, whether they represent the executing party, the clearing house, or the back office, has access to information regarding the status of a trade. From reconciliation with clearing brokers for the buy side, to reconciliation with customers for the sell side, the matching engine 350 provides a user interface that shows the status of orders, fills, and matching. Matching engine 350 allows firms to manage electronic block trading by tying together block trades from buy-side proprietary systems with multiple fills on an execution system. Matching engine 350 is adapted to link trade orders to order fills, and fills to cleared trades so that futures and options management system origin, trading environment (e.g., algorithmic), and strategy (e.g., spread/block/basis) can be included on booked trades for commission calculations. Matching engine 350 facilitates managing the next day (T+1) reconciliation between an order given to an execution firm and cleared trades booked in the back-office systems of multiple clearing firms. In an example embodiment, matching engine 350 is adapted to act upon inputs received by the trade processing system correcting next day (T+1) trade breaks. Matching engine 350 executes against business defined matching rules allowing for certain allowable tolerance definitions. If something is matched within allowable tolerance(s), it is assigned an associated “reason code” and a “comment.” Matching engine 350 is adapted to allow users to override the automated matching, should the user identify a better match scenario. During the matching process, the engine may identify conditions in which further action is warranted. Match results which require manual intervention will be brought to the user for action. Where applicable, the engine will match within specified criteria thereby reducing the interaction the user must perform to complete the trade cycle.

Matching engine 350 is adapted to provide statistics on the matching and reconciliation of the trades over time, such as, for example, over the course of a day, week, month, year, etc. Matching engine 350 is adapted to provide essentially any type of statistic that can be derived from the collected trade and reconciliation data, including for example: fills matched to original clearing trades; fills without original clearing trades; original clearing trades without fills, fill-original clearing trade match exceptions which may further designate the reason for the exception; broker alerts; and customer alerts.

Trade processing system 130 further comprises allocation engine or server 360. Generally, allocation refers to the process of identifying for a particular trade, the one or more accounts to which the trade applies and the amount of the trade that corresponds to each account. For example, a buy side firm may trade for many accounts. Furthermore, a buy side firm may request a trade, a portion of which applies to each of a plurality of accounts. When the trade is complete, the buy side firm must allocate the results of the trade to each of the accounts on behalf of which the trade was made. Allocation engine is adapted to manage the entry and confirmation of post trade allocation information into the system. The allocation engine is adapted to receive allocation information from buy side firms to its various accounts and store that information in processing system's 130 databases. The allocation information immediately becomes available to the corresponding sell side firm for the particular trade.

Allocation engine 360 is adapted to receive and enforce allocation rules. For example, an administrator may enter information specifying one or more defined allocations. Allocation engine 360 allows the trading parties to define the allocation rules based on weights for a particular account. Additionally, whether or not a particular account is active or inactive can be controlled at the rule level, or in the case of an account becoming invalid for all processing, the trade processing system maintains the integral relationship between the accounts and the services built on top of the primary structures. For example, a predetermined allocation may specify that a first account, account A, has a first weight, referred to as 1X, a second account, account B, has the same weight as the first account, 1X, and third account, account C, has a second weight, 2X. Using these weights, a trade of four (4) units would be allocated with one (1) unit to account A, one (1) unit to account B, and two (2) units to account C. The allocation engine stores predefined allocation rules in the database. When an interface for allocation functionality is created and presented to a buy side, the predefined allocation rules are made available for selection by the user for application to a particular trade. Allocation engine 360 is adapted to receive user inputs defining to establish odd lot accounts and logic surrounding those accounts such that residual lots that are not equitably allocated automatically by the rules, have subsequent logic applied to determine which account should receive the odd lot.

According to another aspect of the allocation engine, the allocation engine may accept user-defined allocations. For example, the allocation engine allows for buy side firms to upload from, for example, a spreadsheet or other system that define allocations to be applied to trades.

As illustrated in FIG. 3, trade processing system 130 further comprises an archiving engine that is adapted to archive trade-related information that is aggregated and received by the system. The data may be aggregated, for example, in database 132. Trade processing system 130 is adapted to drive reporting, decision support and other related data analysis from a centralized data warehouse that contains standardized trade, account, and related data from the network of participants coupled with a comprehensive historical audit trail of system and human activity. Data across a broad community of both buy side and sell side firms can be accessed in an easier and timelier fashion for analysis such as trend detection, relative performance, etc. Processing system 130 may access archived information to provide billing and reporting features as well.

FIG. 5 is a diagram depicting functional components of an illustrative sell side user interface. As shown, trade processing system 130 provides a plurality of functional capabilities to the interface accessed by sell side firms. For example, a sell side user interface may comprise a sell side dashboard interface functionality, a sell side alert screen user interface, a sell side trade navigator user interface, an account setup screen, an account matching screen, and a sell side allocation navigator, amongst others.

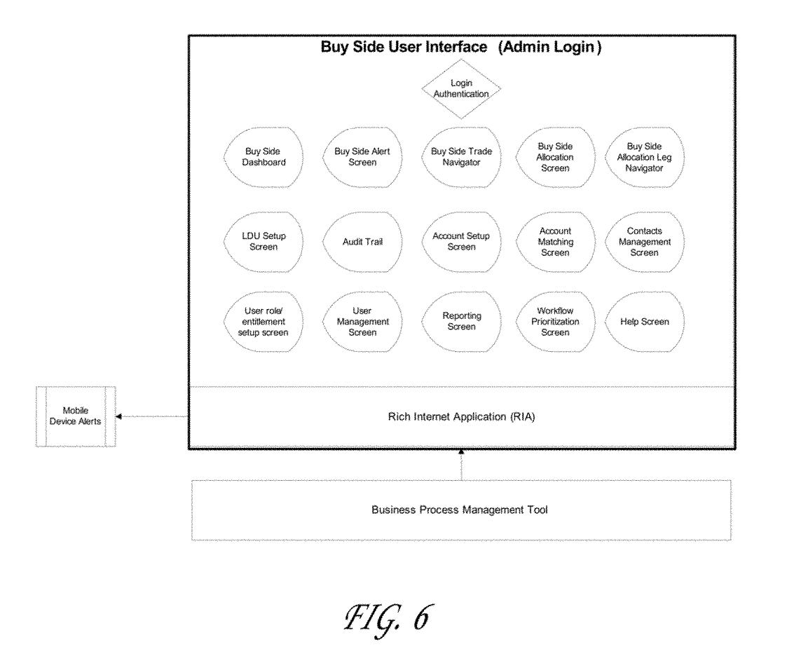

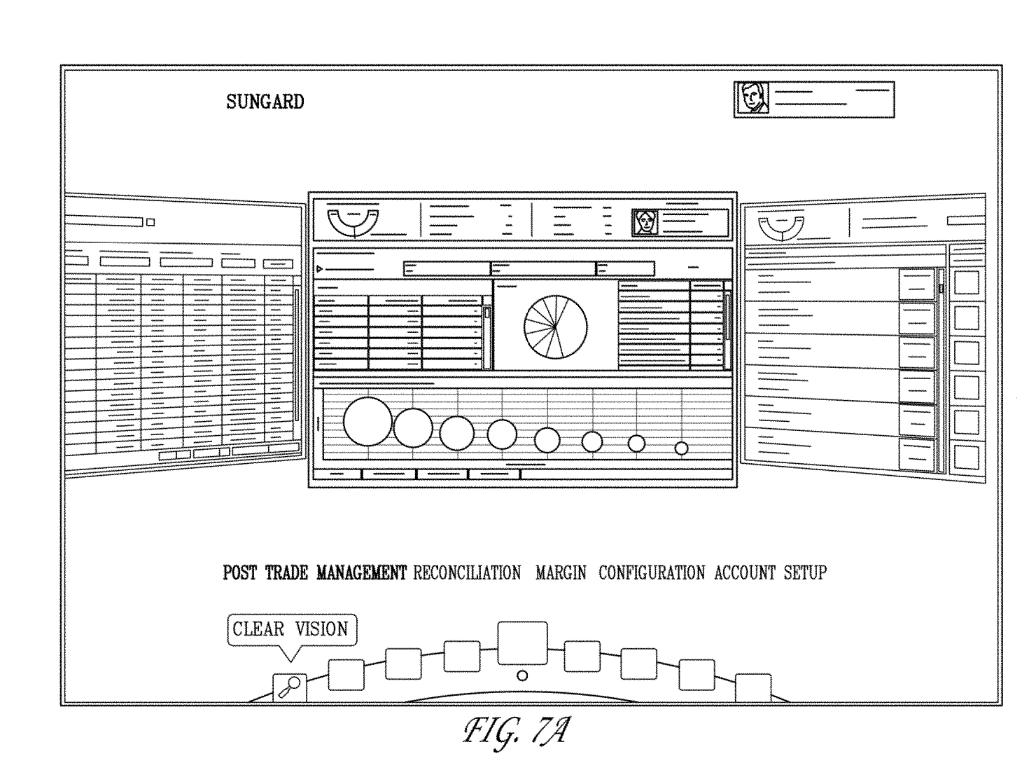

FIG. 6 is a diagram depicting functional components of an illustrative buy side user interface. As show, trade processing system 130 provides a plurality of functional capabilities to the interface accessed by sell side firms. For example, a buy side user interface may comprise a buy side dashboard interface functionality, a buy side alert screen user interface, a buy side trade navigator user interface, an account setup screen, an account matching screen, and a buy side allocation navigator, amongst others.

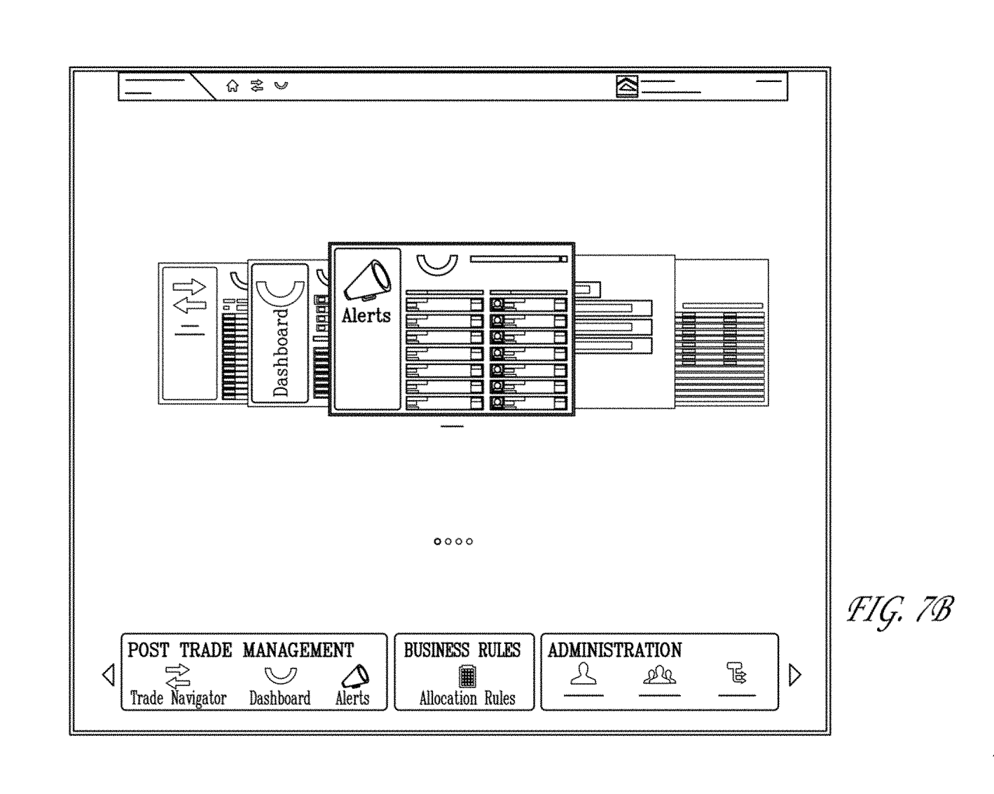

FIGS. 7 through 22 illustrate a series of user interface screens provided by the trade processing system 130 and adapted to be accessed and used by sell side firms. Trade processing system 130 provides access to a wide set of feature of functionality which may be accessed via any acceptable user interface. For example, as shown in FIG. 7A, a user associated with a trade side firm may be presented with a triptych view of three screens. In the illustrative embodiment depicted in FIG. 7A, a buy side dashboard screen is illustrated in the center of the triptych, a buy side trade navigator screen is illustrated on the left of the triptych, and a buy side alert screen is illustrated on the right of the triptych. Using this interface, the user can easily select a particular screen, as well as navigate between screens. The user may click on any one of the three screens to zoom into the particular screen. The user may also select to access a particular functional set by selecting the desired area from the listing at the bottom of the screen. For example, a user may select “Margin” to access functionality relating to margin workflows. The margin functionality is adapted to provide transparency on margin requirements for each exchange.

FIG. 7B depicts an alternative user interface from that depicted in FIG. 7A. As shown in FIG. 7B, a user associated with a trade side firm may be presented with a scrolling array of modules. The header of each screen has quick navigation links which allow users to go directly from one module to another without needing to navigate the hierarchy within the trade processing system. The user may select to access a particular functional set by selecting the desired area from the listing at the bottom of the screen. For example, a user may select “Margin” to access functionality relating to margin workflows. The margin functionality is adapted to provide transparency on margin requirements for each exchange.

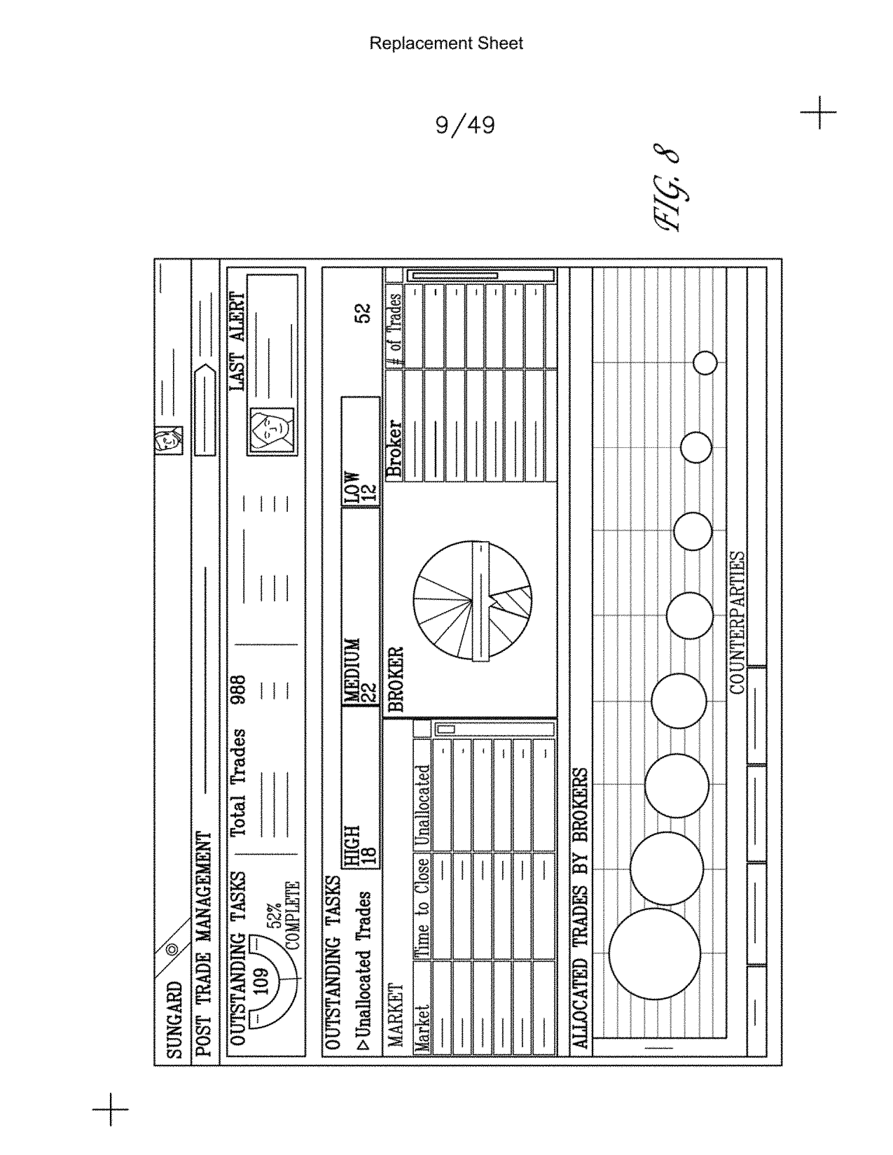

FIG. 8 provides a detailed view of a buy side dashboard. In the buy side dashboard, the user is provided with an aggregate view of the trades that the particular buy side firm has open across all brokers. A top portion of the panel comprises a summary of the trade status for the particular buy side firm. For example, the top panel specifies the total number of trades and provides a breakdown of the allocated and unallocated trades. The left portion of the panel provides a total of the number of tasks outstanding for the firm for the particular trading day. In the case of buy side activities, the outstanding tasks comprise allocation of trades. In an exemplary embodiment, a task curve is presented that illustrates the percentage of tasks that remain to be completed.

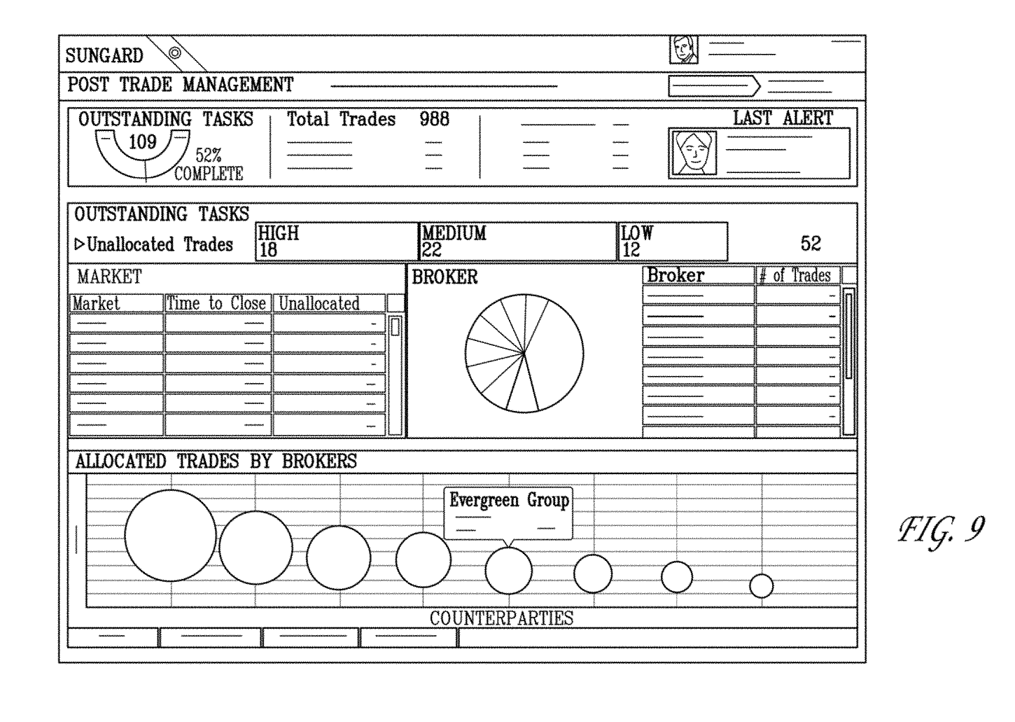

A middle panel of the screen provides information regarding the outstanding tasks for the particular firm. A top portion of the middle panel breaks down the unallocated trades between high, medium, and low priority trades. Other priorities breakdowns can be defined by a firm and utilized in the trade processing system. The priority for unallocated trades is determined based upon rules that are designated by the administrator using the rules engine. For example, the rules engine may define that the unallocated tasks corresponding to an exchange that is closing within a prescribed period of time should be designated as high priority. The left side of the middle panel comprises a list for the particular buyer of the unallocated trades broken down by the exchanges on which the trades were executed. The right side of the middle panel comprises a list of the number of unallocated trades the firm has with each of a plurality of brokers. The unallocated trades broken down by broker are illustrated in a pie chart to the left of the numerical listing. The same data is represented below the middle panel using a series of orbs with the relative sizes of the orbs representative of the relative number of trades that are unallocated. In the exemplary embodiment of FIG. 8, if the selects an item in the list of brokers, the corresponding pie section for that broker is highlighted. As shown in FIG. 9, if the user selects one of the orbs in the bottom panel, detailed information regarding the trades executed by the particular broker for the buy side firm are presented.

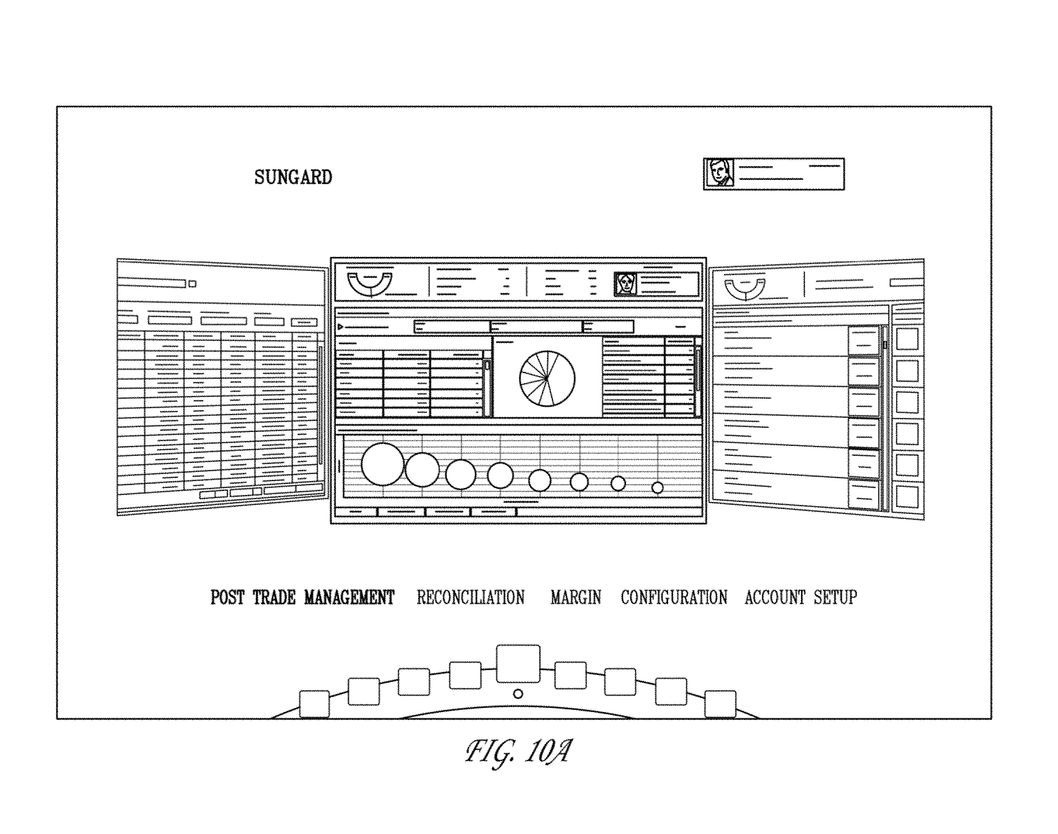

FIG. 10A illustrates that the user of the buy side user interface may zoom out to return to the triptych interface that was depicted in FIG. 10A. The user may then select to zoom in on the left screen, which is the buy side trade navigator screen. Similarly, FIG. 10B illustrates that the user of the buy side user interface may zoom out to return to the scrolling array of modules interface that was depicted in FIG. 10B. The user may select to scroll to the buy side navigator screen.

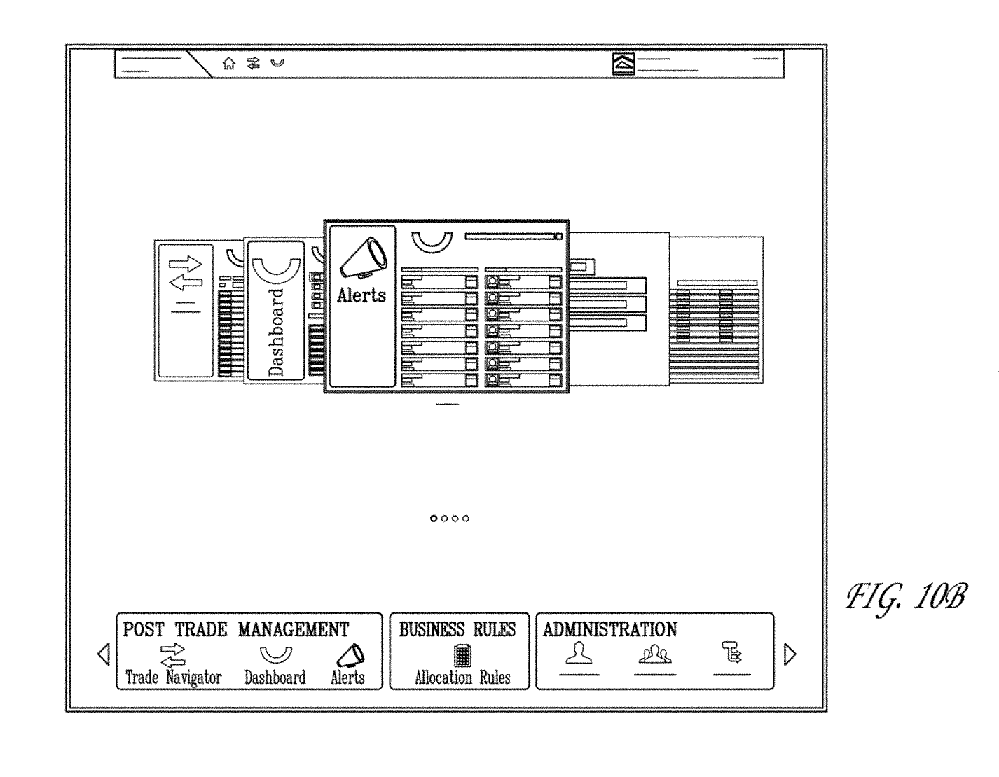

FIG. 11 provides a detailed view of the trade navigator screen. As shown, the trade navigator user interface screen provides a screened and sorted listing of trades across all brokers/sell side firms that the buy side firm has traded with. In the particular screen of FIG. 11, the screen depicts a sorted list of high-priority unallocated trades. The trade processing system allows user defined sorting and filtering, and user defined views of the data on the screen and the order in which data elements are presented via drag and drop usability, thereby allowing the user to customize the view of the universe of data that meets his or her needs, and subsequently save it for future use. The buy side operator can view at a glance the trades that have not been allocated and which have been designated as high priority for allocation. The upper left portion of the screen displays a curve illustrating the total tasks and total number of tasks that are outstanding. The trade processing system allows for the synthetic and algorithmic average pricing of trade data both via an exchange and directly to back-office systems.

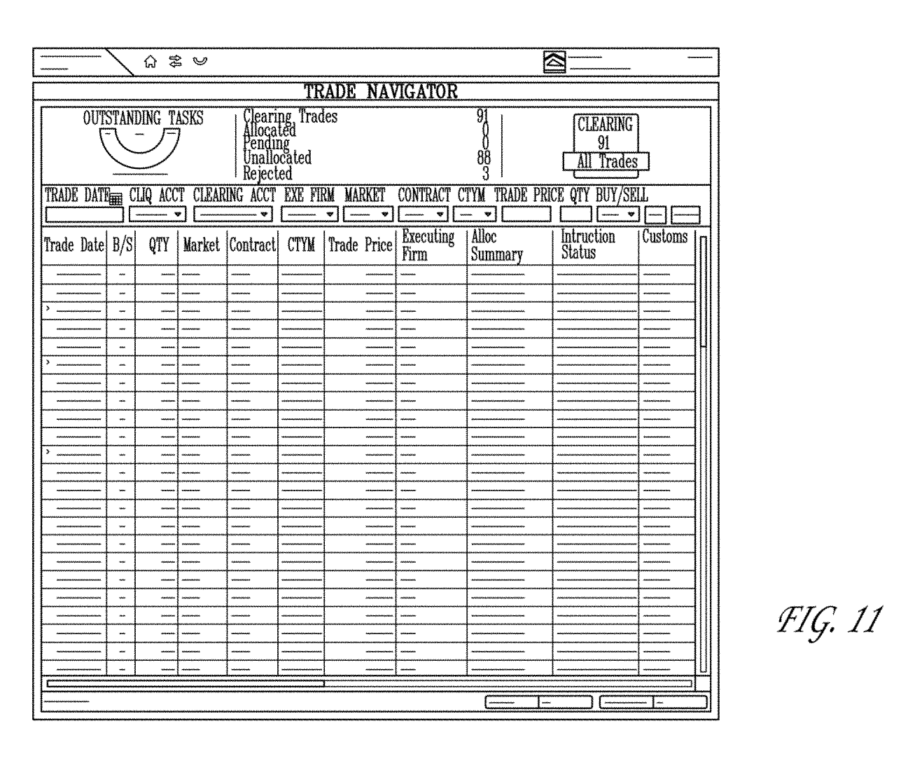

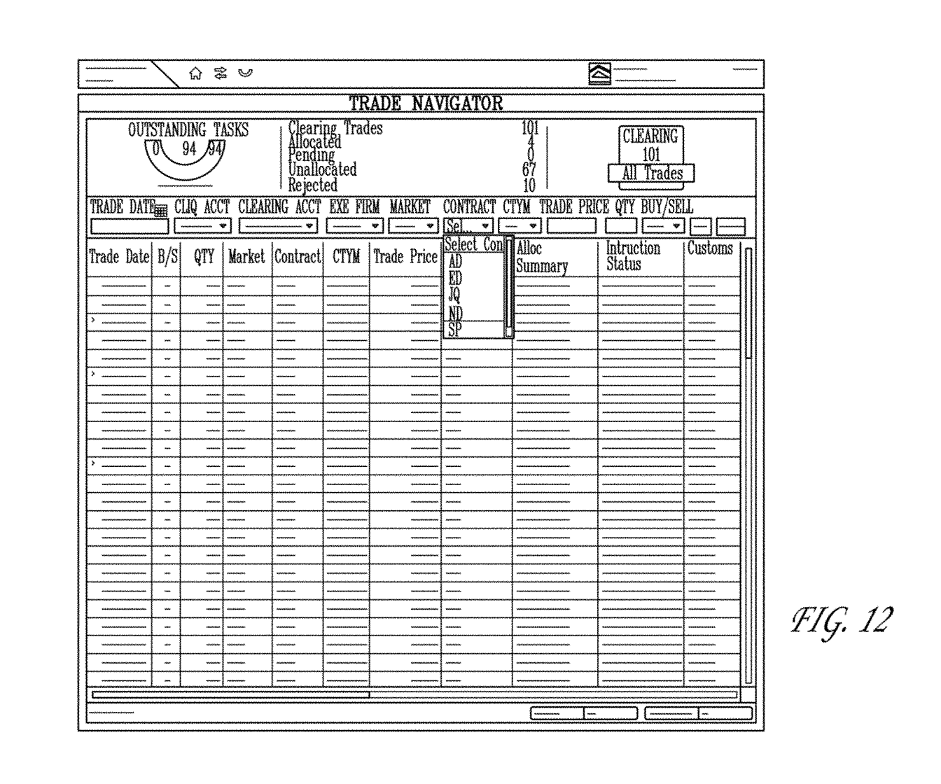

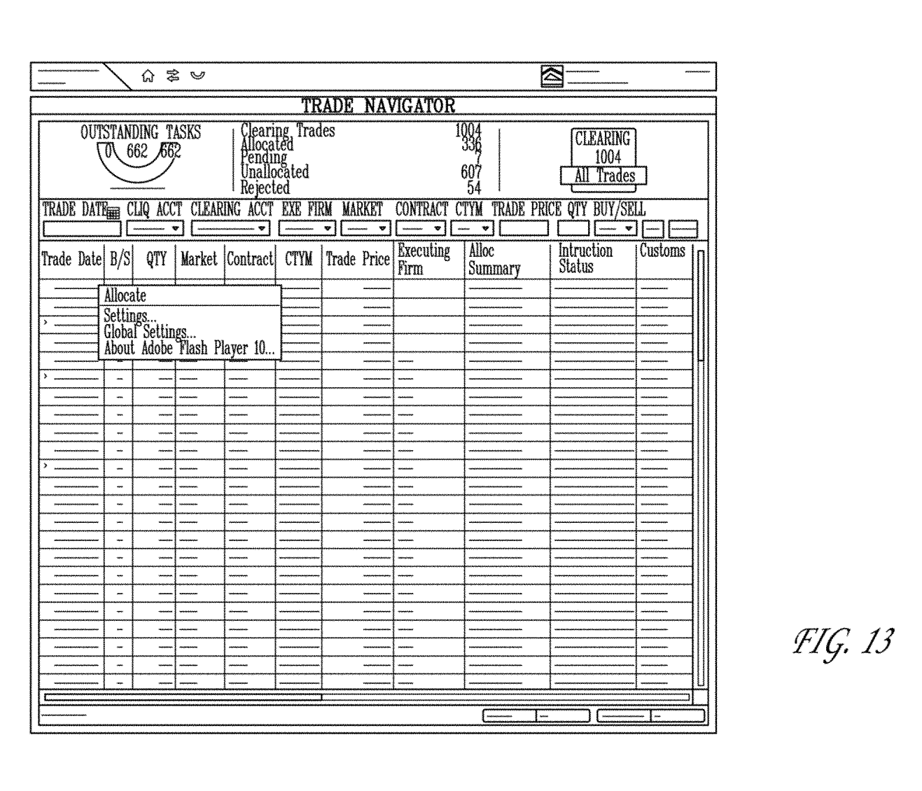

As illustrated in FIG. 12, the user may enter a screening value in order to screen for particular unallocated trades. In the exemplary scenario of FIG. 12, the operator has selected to screen for high-priority unallocated trades that are SP contracts. FIG. 13 provides a view of the trade navigator screen illustrating the results of the screening for SP contracts. As shown in FIG. 13, the user may select a particular trade and, possibly by right-clicking on the trade, receive a list of actions, one of which is to allocate the trade.

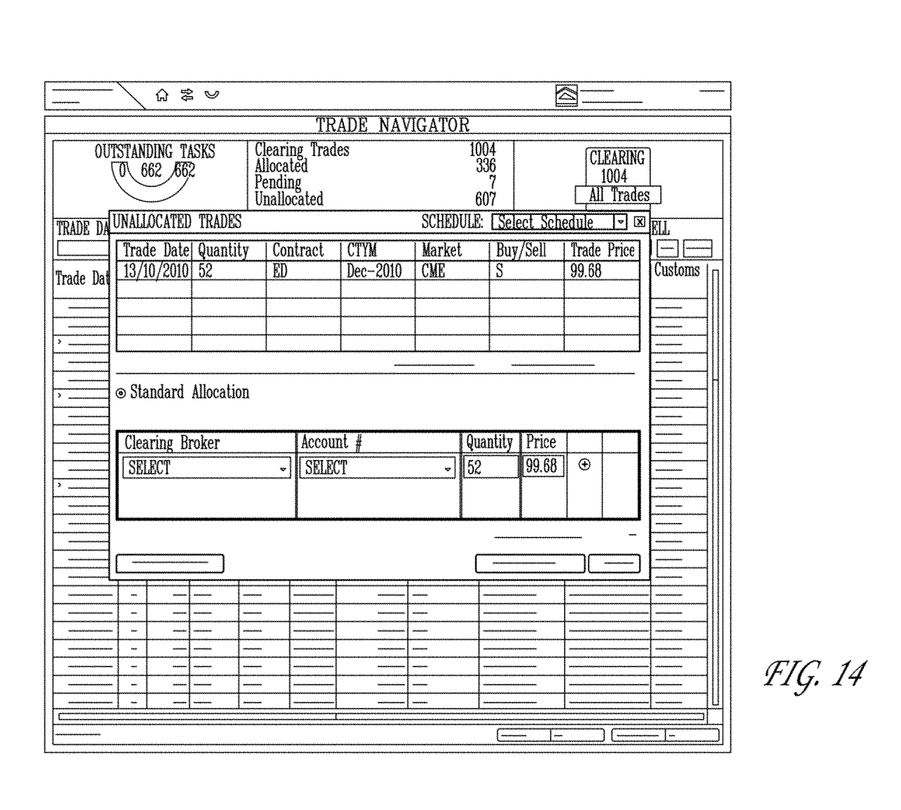

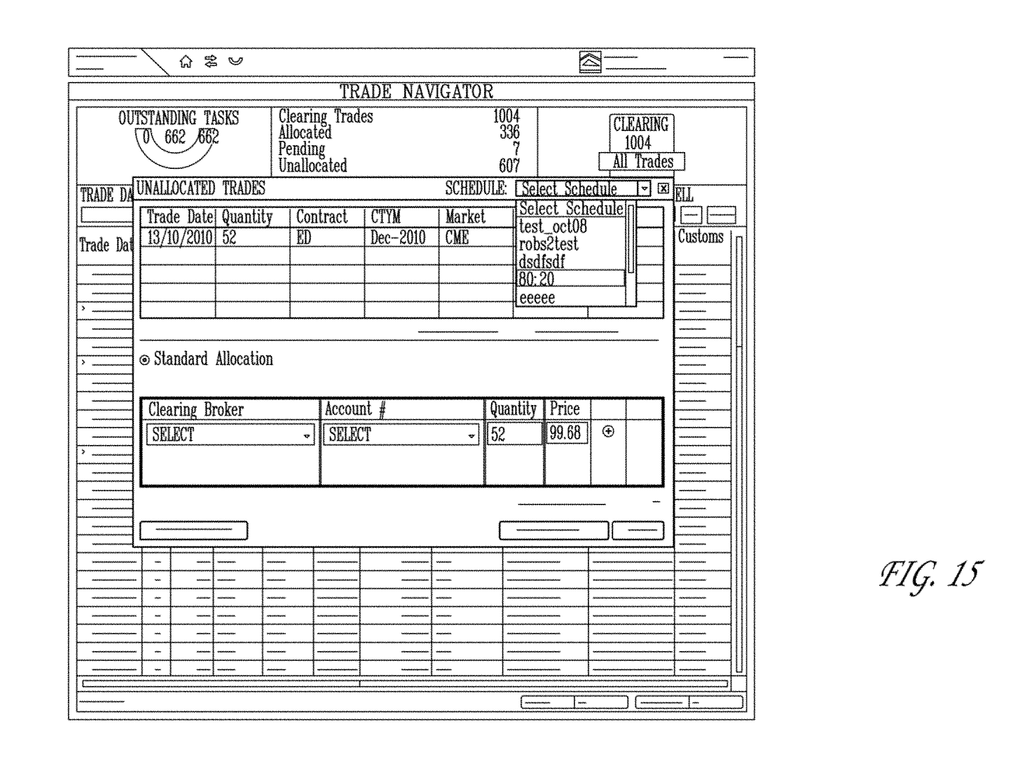

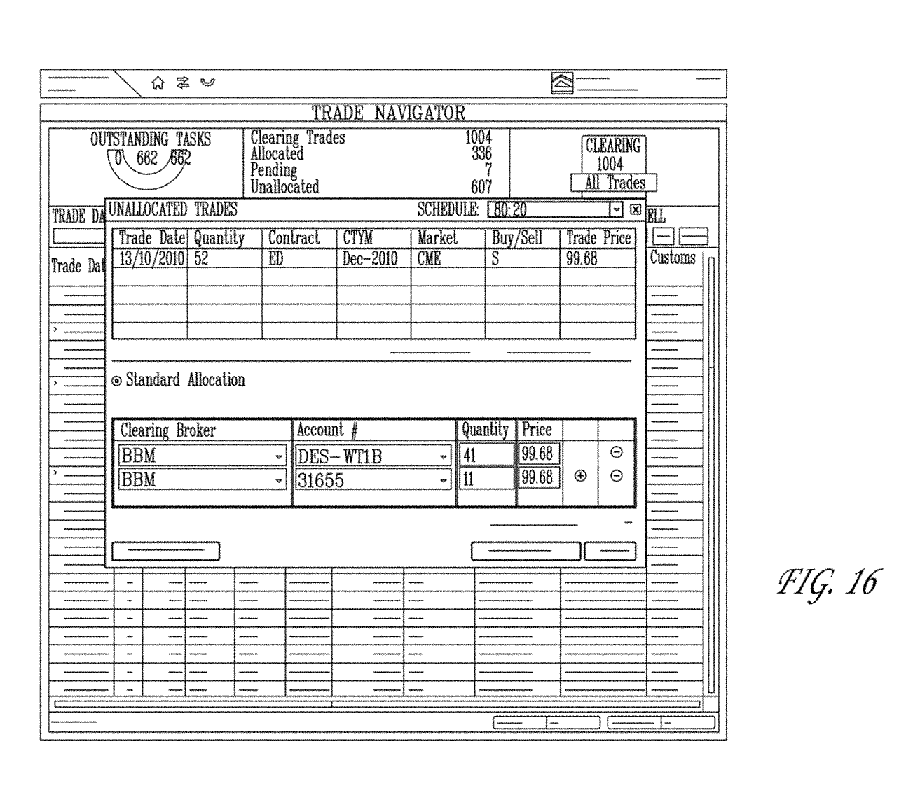

FIG. 14 provides an illustrative view of a pop-up displayed on the trade navigation screen that is provided in response to the allocation request. As shown, information regarding the trade that is being allocated appears at the top of the screen. The user may enter the allocation manually using the appropriate fields at the bottom of the pop-up screen. Alternatively, the user may select a pre-defined schedule using, for example a pull down menu such as is illustrated in the upper right section of the pop-up screen. FIG. 15 illustrates a pop-up allocation screen with the menu items of the drop down menu displayed. As shown, several allocation schedules are shown, each with a different distribution. In response to a user selecting one of the entries, the distribution corresponding to the selection is automatically populated in the allocation listing appearing at the bottom of the menu. FIG. 16 provides a view of the allocation pop-up after the user has input information specifying the particular accounts that are to be allocated the various percentages that were selected allocation schedule. After entering the information, the user selects to complete the allocation.

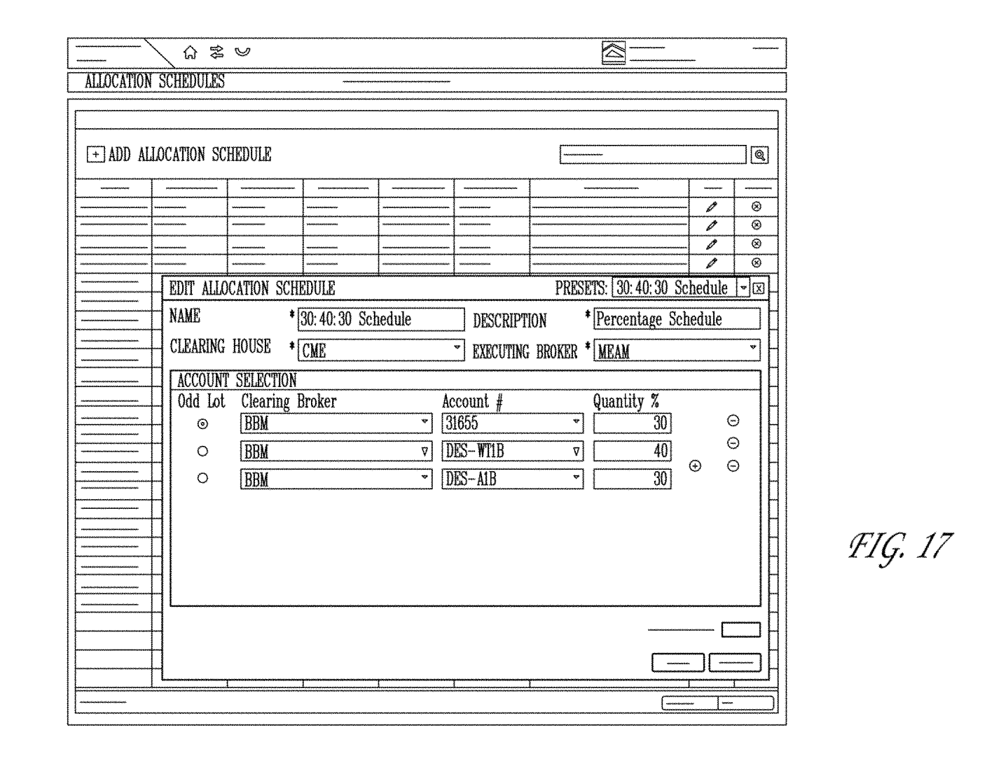

FIG. 17 illustrates a pop-up screen that may be used to view and modify the details of a predefined allocation schedule. As shown in FIG. 17, the identification information for the particular pre-defined allocation schedule is listed at the top of the screen. The bottom of the screen lists the allocation between accounts. Users may manually change the allocation information, including whether an allocation is an odd lot, using the data entry fields and user input controls on the lower portion of the screen.

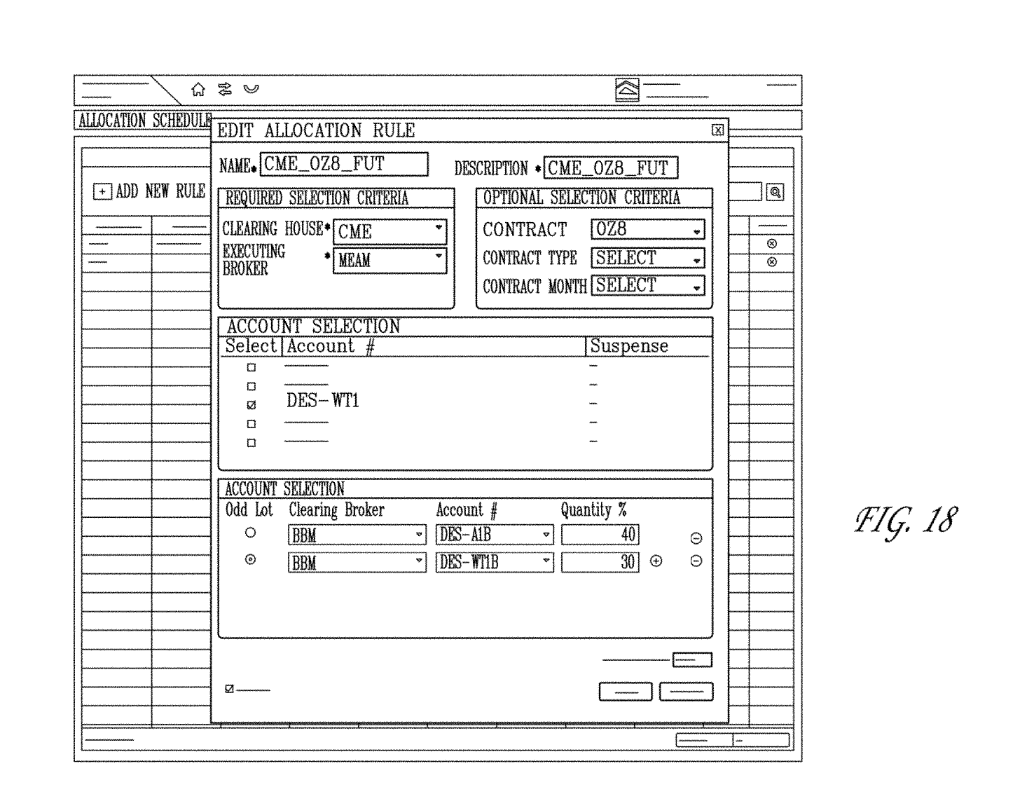

Trade processing system 130 is adapted to automate the process of allocating trades. Thus a trade received into a particular account may be automatically allocated to a pre-defined set of brokers. Using trade processing system 130, system operators may define the rules that dictate such automated allocation. FIG. 18 depicts an illustrative screen for defining an allocation rule. As shown in FIG. 18, the name of the allocation rule is listed at the top of the screen. An operator may designate all of the relevant information for performing an allocation including, for example, the clearing house, the broker, the relevant accounts, and allocation percentage.

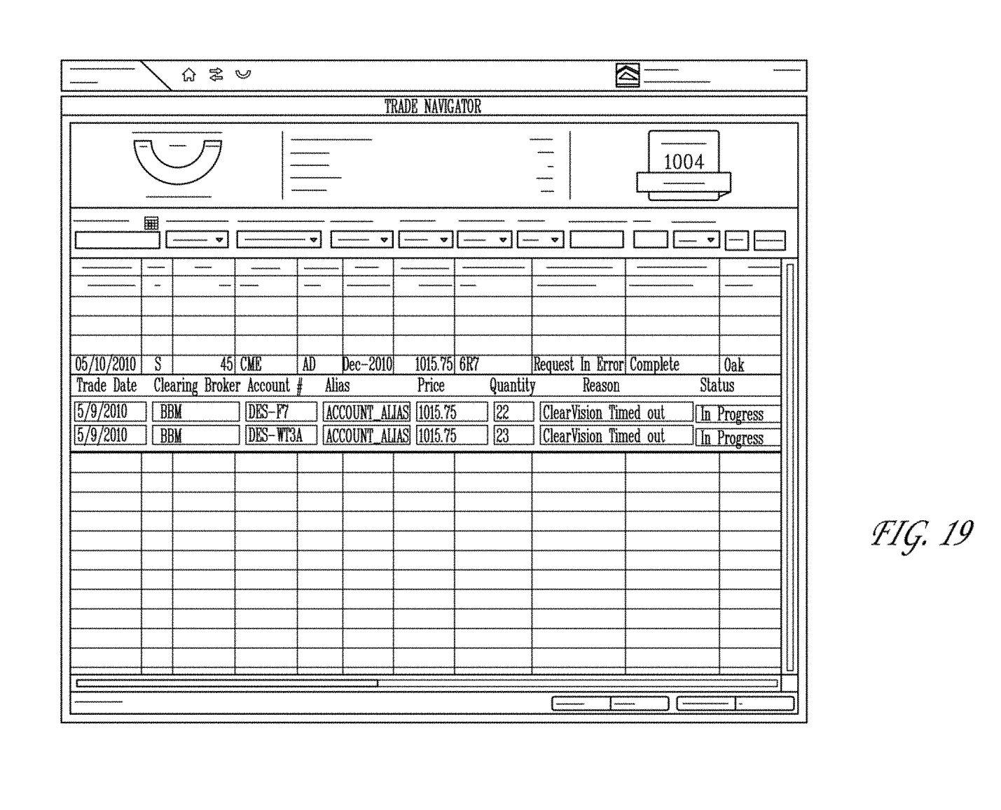

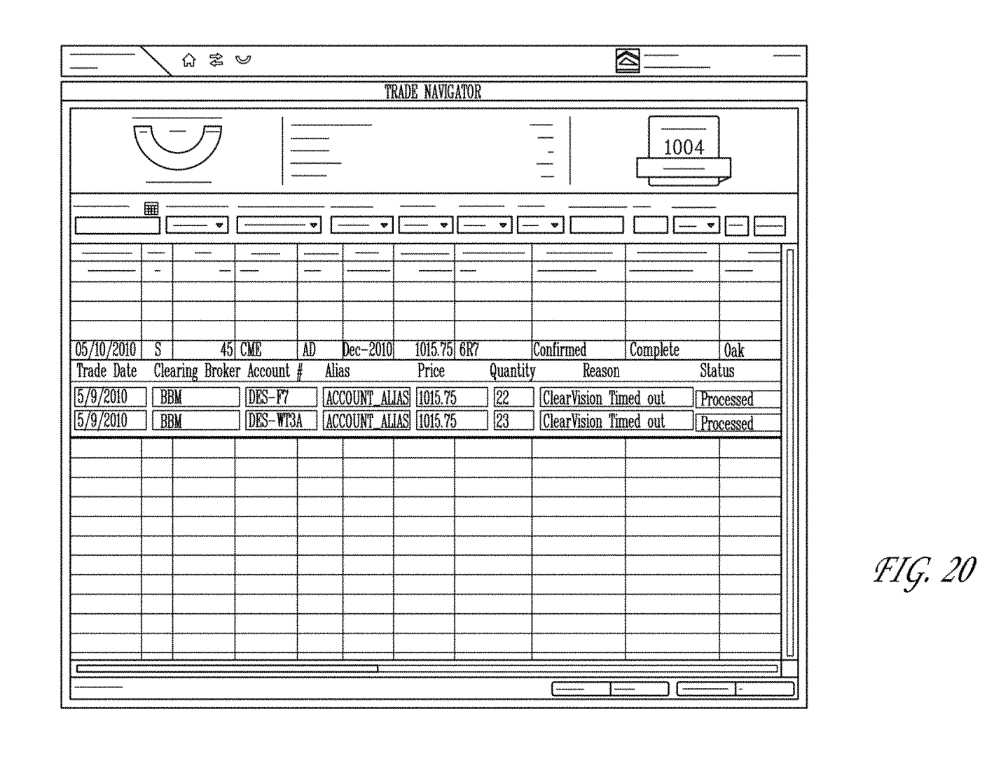

As shown in FIG. 19, in response to a user specifying to complete the allocation, the pop-up allocation screen is removed and the user again presented with the trade navigator screen which now displays the different accounts to which the particular trade has been allocated. The screen further comprises a status bar indicating an allocation status for each of the accounts. The status represents whether the allocation in progress (pending) or processed (allocated). FIG. 20 illustrates the navigator trade screen after the allocation has completed for each of the two accounts to which the trade has been allocated.

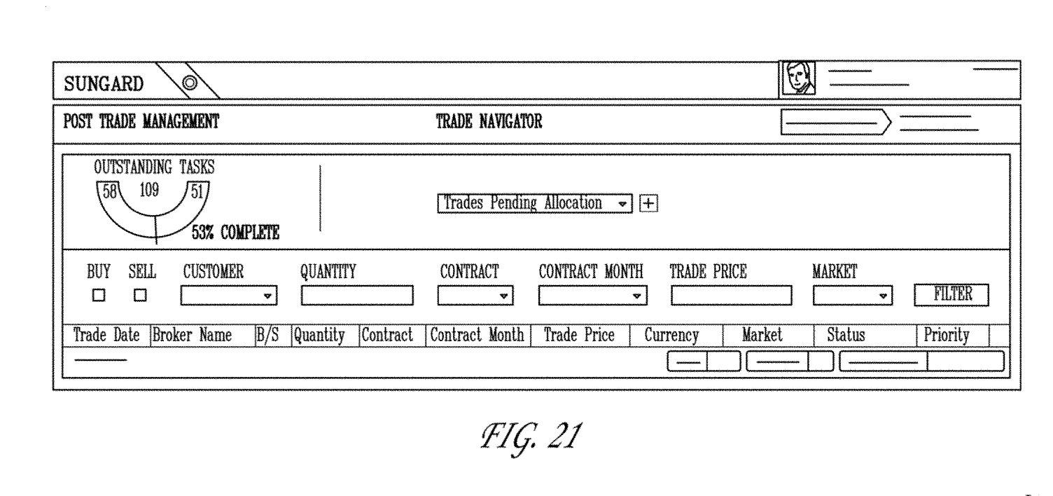

The user may continue to select trades from the sorted list in the trade navigator screen and allocate the trades as described above. As trades are allocated, they are removed from the listing of trades requiring allocation. When all trades have been allocated, there are no trades to be listed as unallocated in the trade navigator screen as illustrated in FIG. 21.

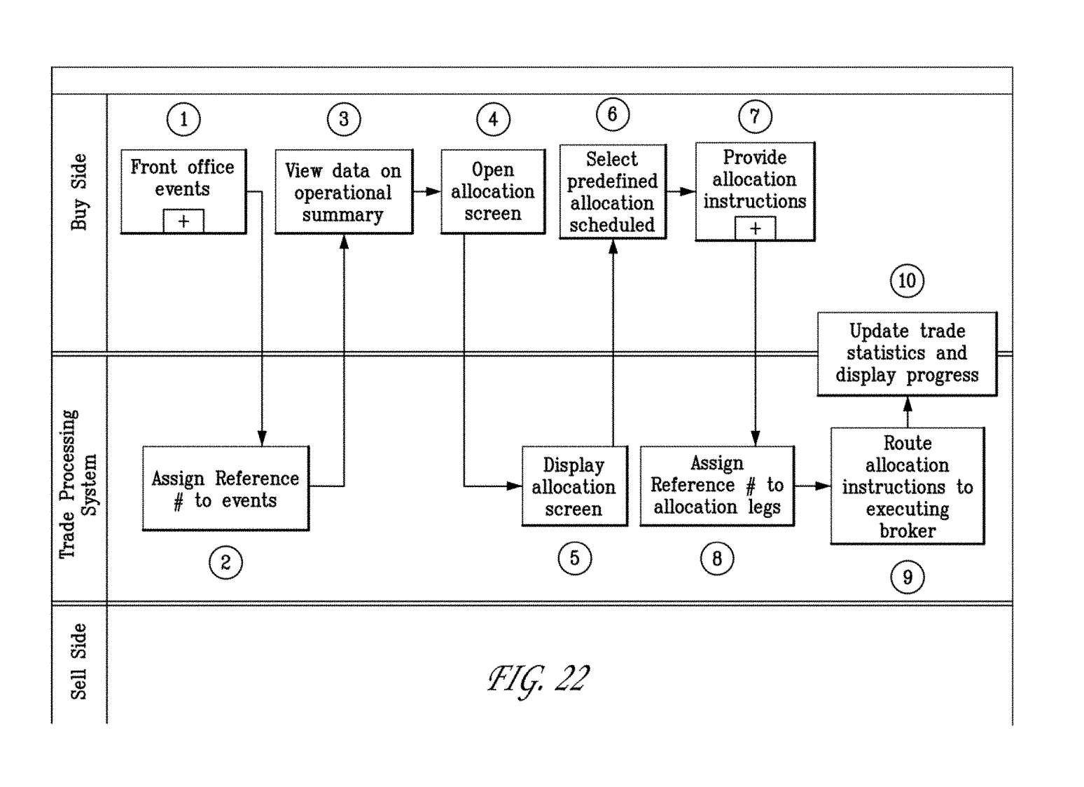

FIG. 22 provides a chart illustrating an exemplary flow of processing in trade processing system 130 for a buy side allocation. The flow may be facilitated by the workflow control provided by the business process management layer 310 of the system. The business process management layer 310 may prioritize the workflow for trade processing between buy-side and sell-side users. The system can assign tasks to users, escalate task priorities, and accept user defined rules for task escalation and priority. In the exemplary flow of FIG. 22, at step 1, several front office events occur before trades are received into the system. These events include the buy-side placement of the trade order with the sell-side firm. The sell-side firm receives fills from the exchanges that execute those trades and then clears the trades with the appropriate clearing house. The trade enters the system in a cleared status and pending allocation. At step 2, the system assigns a reference number to the cleared trades.

At step 3, the buy-side user, upon logging into the system, reviews the Operational Summary to gain an understanding of the volume and priority of the cleared trades. At step 4, the buy-side user opens the Trade Navigator whereby access is provided to the allocation screen. The user must select a particular trade or set of trades and initiate a call to the system indicating the need to process an allocation.

At step 5, the system calls the trade database to identify the necessary trade data and displays that data on the allocation screen. In response, at step 6, the buy-side user chooses the method of allocation. In an example scenario, the user selects a pre-defined allocation schedule. The user validates the schedule by reviewing the data on the allocation screen. The user has an ability to make adjustments to the allocation based on interaction with the system. At step 7, the user submits the final allocation instruction to the system for trade processing.

At step 8, the system assigns reference numbers to each allocation leg. An allocation leg is a portion of the trade quantity that is assigned to a brokerage account. Since a single trade may be allocated to many accounts, it is necessary for the system to maintain a reference number for each allocation leg. The system also associates the allocation leg reference numbers with the trade reference numbers assigned above at step 2.

At step 9, the system routes the allocation instructions to the sell-side firm that cleared the trade and is waiting for the buy-side allocation instruction. Once the allocation instruction is received by the sell-side firm it can be further processed in the back-office systems of the sell-side firm. At step 10, the system updates the trade statistics on both the Operational Summary/Dashboard and Trade Navigator user interface screens discussed above.

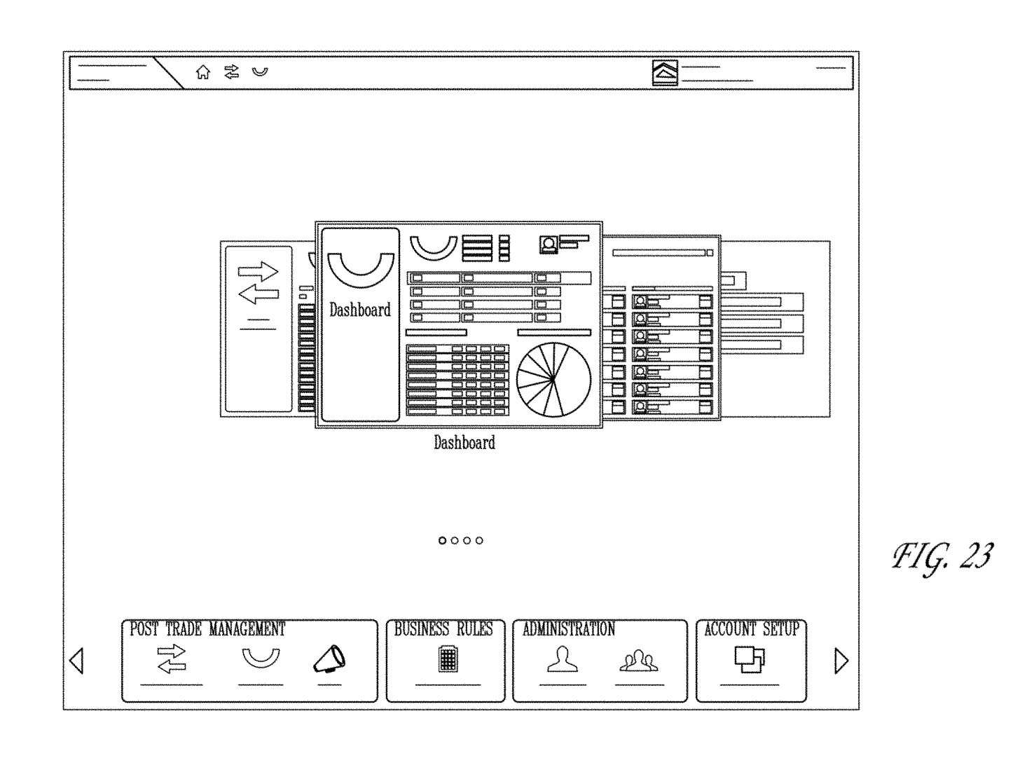

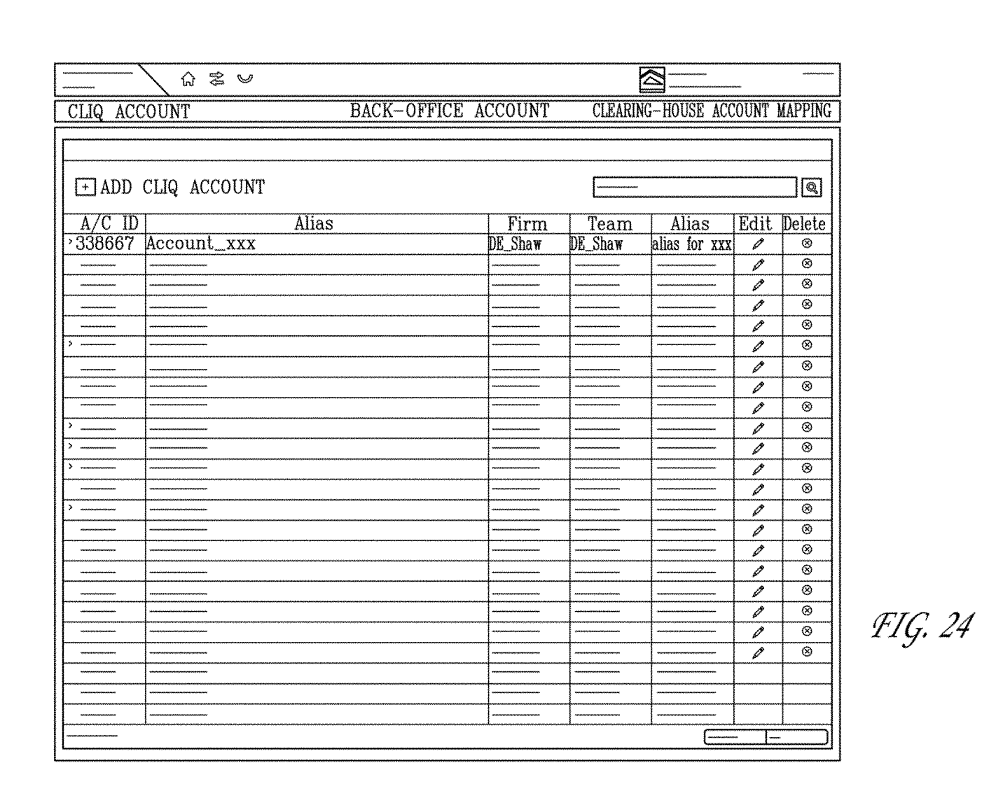

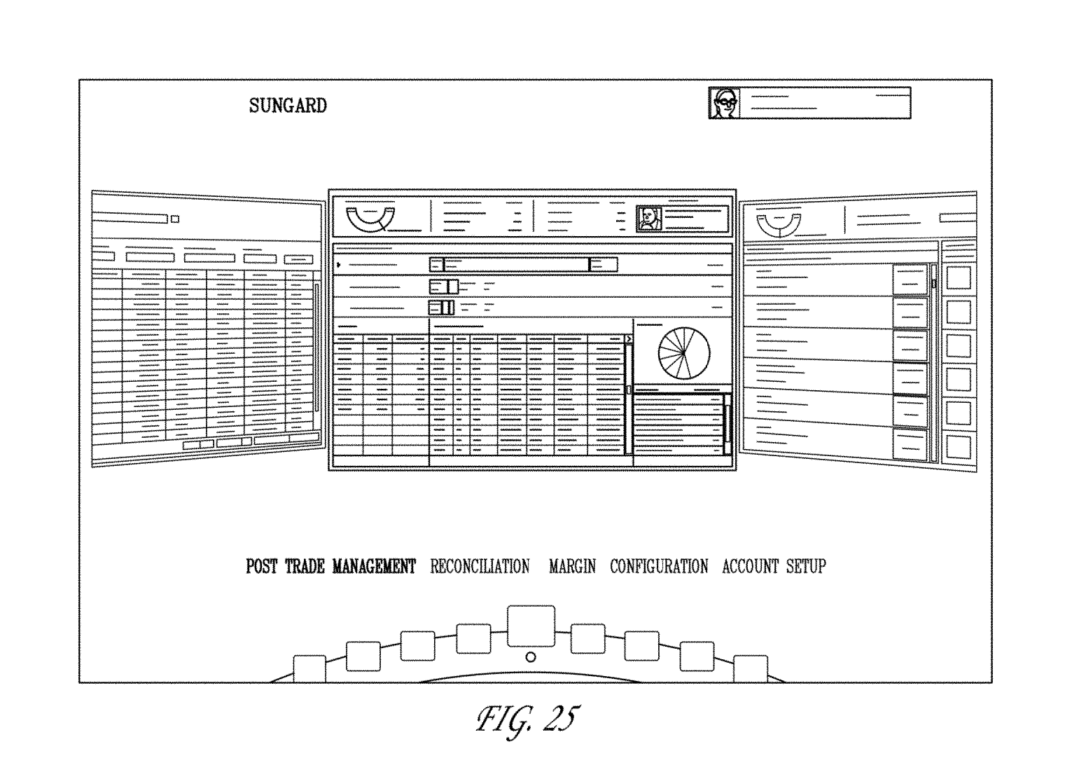

Returning to the exemplary user interfaces for buy-side processing as depicted in FIG. 23, the user may select to access any functionality that is provided to buy side firms. For example, the user may select to access account setup functionality. Doing so may cause a screen such as is depicted in FIG. 24 to be displayed. As shown in FIG. 24, the user may specify information relating to a new account for the particular buy side firm. Once the user enters the information for the account, the information is stored in the processing systems database and becomes available for processing of future trades.

FIGS. 25 through 40 provide illustrative screens corresponding to functionality typically associated with sell side firms. As shown in FIG. 25, a sell side firm is presented with a triptych view of screens that are available to the user. In an exemplary scenario, the user may select to zoom in on a sell side operational dashboard which appears in the middle of the depicted triptych.

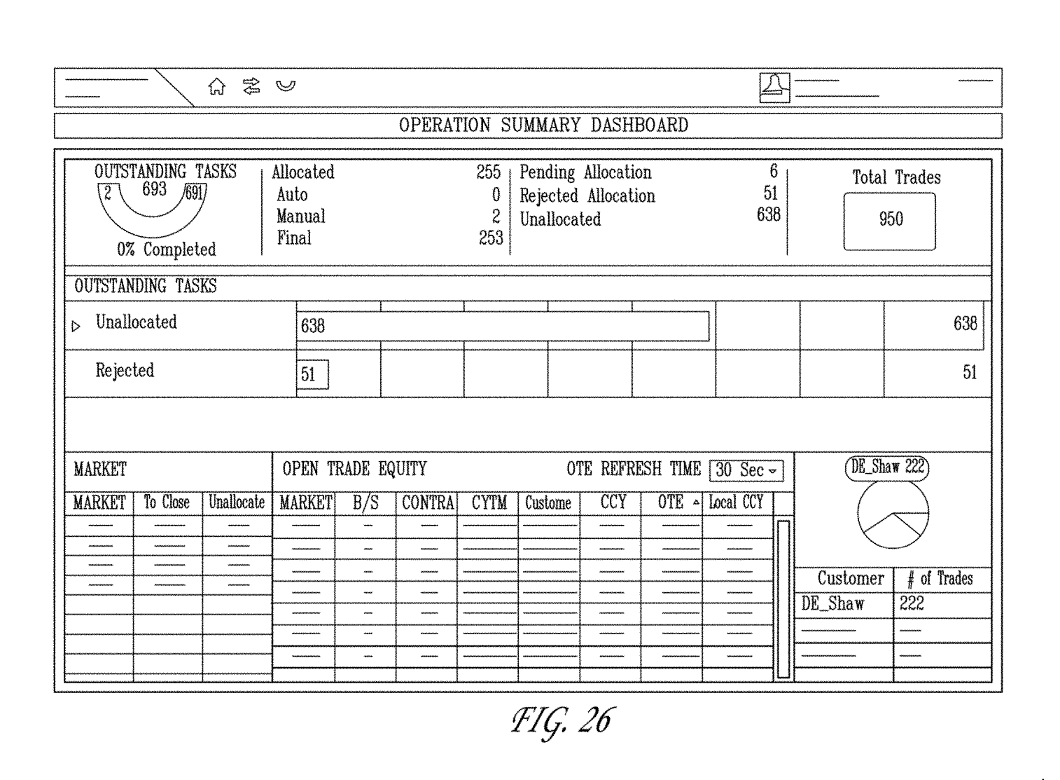

As illustrated in FIG. 26, in connection with the sell side operational summary dashboard, the user is provided with an aggregate view of the trades that the particular sell side firm has or is processing. A top portion of the panel comprises a summary of the trade status for the particular sell side firm. For example, the top panel specifies the total number of trades and provides a breakdown of the allocated and unallocated trades, and the sub classifications associated with those trades. The left portion of the top panel provides a total of the number of tasks outstanding for the firm for the particular trading day. The tasks relate to allocation tasks or corrective actions required to be performed against trade data, setup data, and the like. In an exemplary embodiment, a task curve is presented that illustrates the percentage of tasks that remain to be completed across all buy side customers.

A middle panel of the screen provides information regarding the outstanding tasks for the particular firm. A top portion of the middle panel breaks the tasks down by unallocated trades, rejected allocations, and allocations out for review. With respect to each of these categories, the tasks are broken down by whether the tasks are high priority, medium priority, or low priority. Which tasks are considered high/medium/low priority is determined based upon rules that are designated by the administrator using the rules engine. For example, the rules engine may define that the unallocated tasks corresponding to an exchange that is closing within two hours should be designated as high priority.

The bottom left portion of the panel breaks the unallocated tasks down by the exchange on which they were executed. The list specifies the time until closing for each exchange. This information may assist the user in determining which tasks need to be allocated in the near term so as to be allocated prior to closing of the particular exchange.

The bottom middle portion of the panel provides a listing of open trades with high negative open trade equity. This too assists the operator in designating positions that should be allocated as soon as possible. The bottom right portion of the screen provides a listing of buy side customers that have been services by the sell side firm and designates the number of trades that have been processed for each customer.

In an exemplary scenario, the operator of the screen FIG. 26 may select to view a listing of the high priority unallocated trades. In an exemplary embodiment, the user may make this selection by clicking on the high priority section of the bar under unallocated trades. Making this selection will present the trade navigator screen with the predefined filters for the trades of interest.

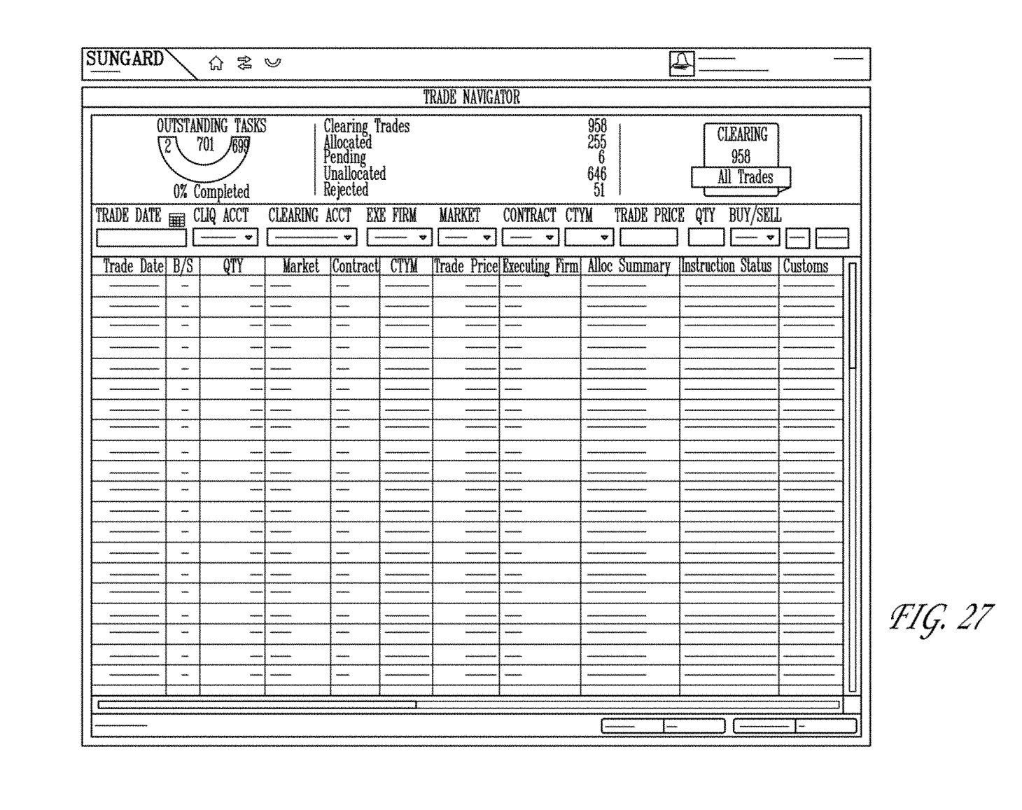

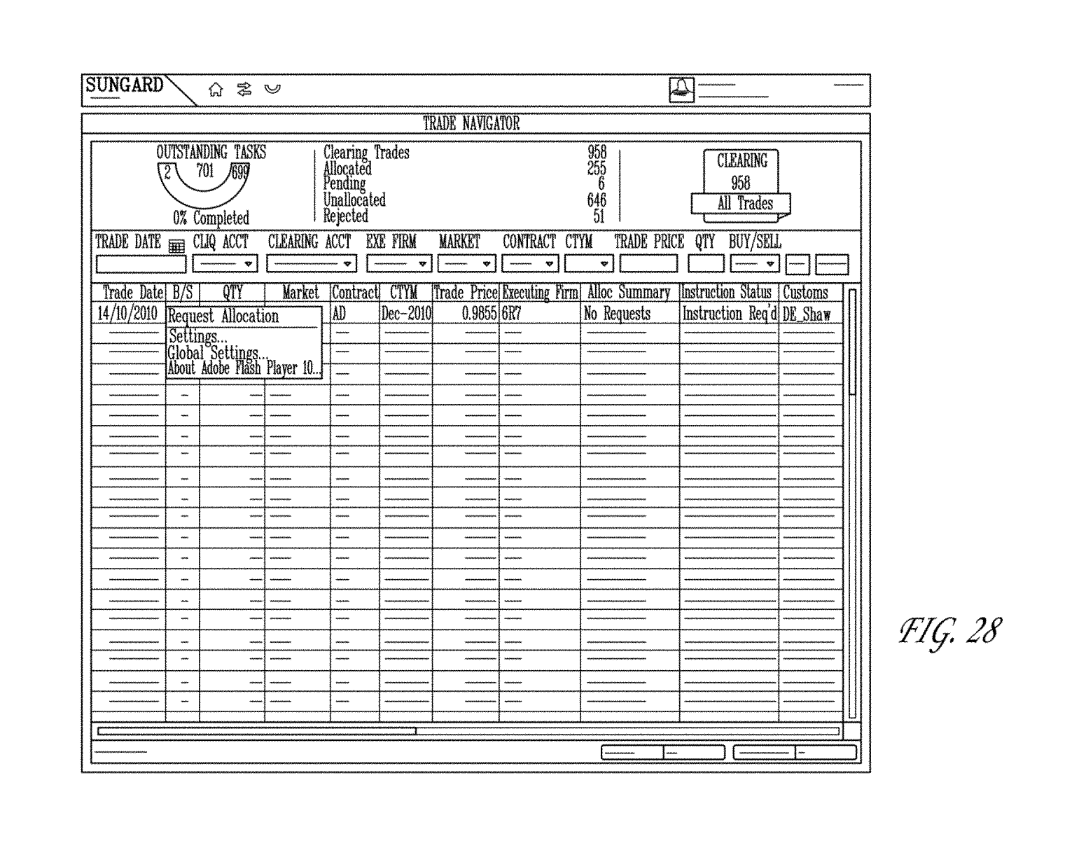

FIG. 27 provides a detailed view of the sell side trade navigator screen. As shown, the trade navigator user interface screen provides a screened and sorted listing of trades across all buy side firm/customers that the particular sell side firm has traded with. In the particular screen of FIG. 27, the screen depicts a sorted list of unallocated trades. The sell side operator can view at a glance the trades that have not been allocated and which have been designated as high priority for allocation. As shown, the trades are sorted by descending trade date. The user can sort the grid data in any manner he chooses and further drill into the data with complex filtering. The upper left portion of the screen displays a curve illustrating the total tasks and total number of tasks that are outstanding.

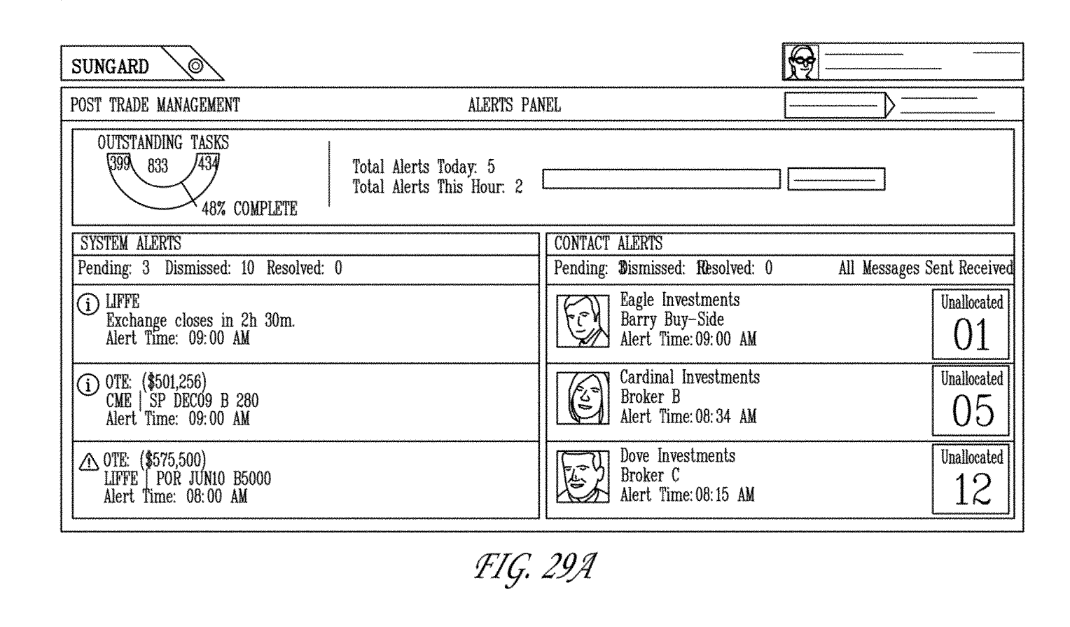

In an exemplary scenario, and as illustrated in FIG. 28, the user may select an unallocated trade from the listing of trades and select to request allocation. In an exemplary embodiment, the user may select the trade and right click on the trade to generate a pull down menu which includes a menu item that may vary depending upon the operator's access rights in the system. According to one embodiment, the menu item allows for designating to request allocation.

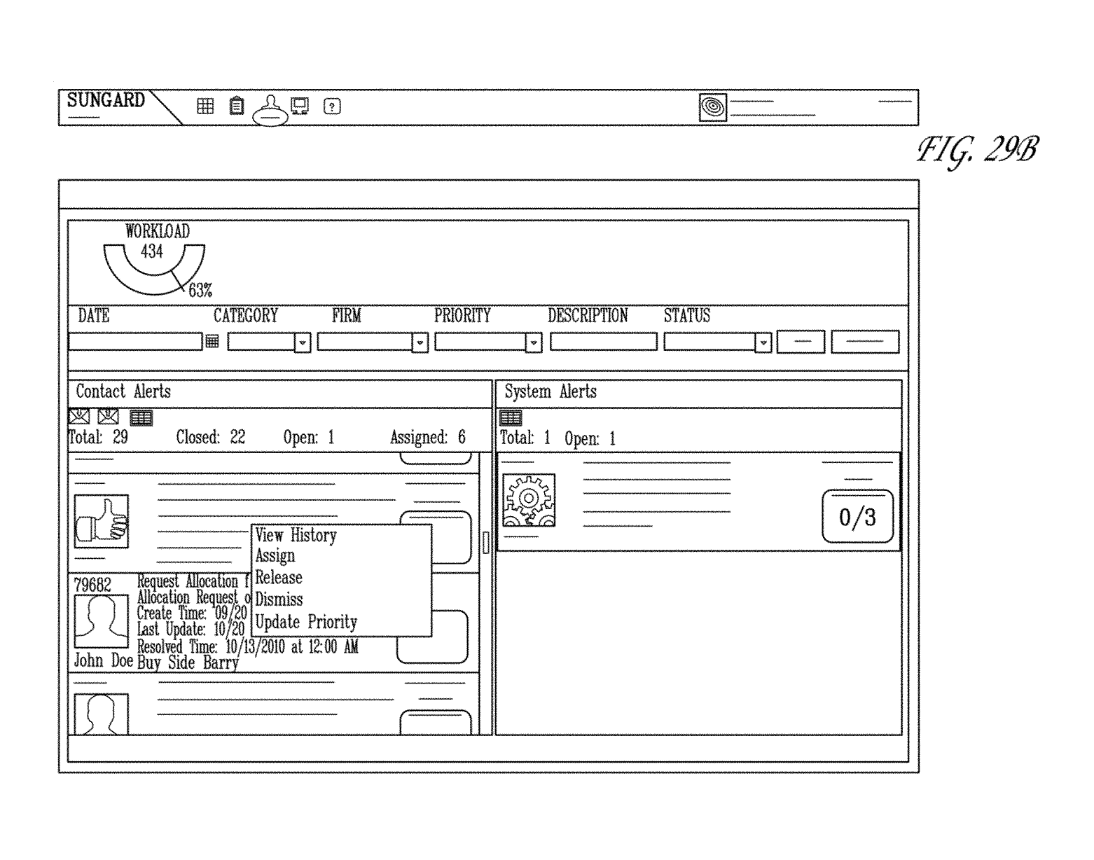

In response to a selection to request allocation, system generates a request allocation alert to the appropriate firm and account management group. The user can see the status of the alert via an alerts panel such as is displayed in FIG. 29A. Alerts generated by the request allocation are categorized by the buy side firm to which the alerts correspond. The listing further specifies the number of associated trade records and the number of associated trade records that have been actioned as displayed in FIG. 29A. The user may specify that an alert be sent to the particular buy side firm that is responsible for the particular unallocated trade. In an illustrative scenario, the sell side firm requests that an alert regarding an unallocated trade be sent to the buy side firm responsible for the trade. Both parties that are impacted by the alert can track the status of the alert through its lifecycle. An alternate embodiment is shown in FIG. 29B. In an exemplary embodiment, the alerts panel provides a status of the alerts that have been created in the particular trading day by default. The alert panel color codes activity by priority and status so as to assist the user in focusing attention using these criteria. The display identifies alerts requiring action as well as the total for the day. The entitlements that a user may perform against an alert are actionable directly from the display. From the same display, the user can view history, release, assign, dismiss or update priority of an alert. Complex filtering allows the user to drill into all alert related data. The alerts panel lists on the right those alerts that were created by the system by the alerts engine according to the predefined rules specified by the particular sell side firm. The left side of the alerts screen provides a listing of alerts generated as a result of specific user generated requests. The user can take a multitude of actions against the alert and the underlying subject records from the alert panel.

As demonstrated in FIG. 29C, the alert grid displays the data in a grid-like pattern, allowing the user to sort, filter, and action data in a flexible framework that the user can control. This view easily demonstrates the status of an alert and the underlying records in a single snapshot and allows the user to drill further into details should they choose to.

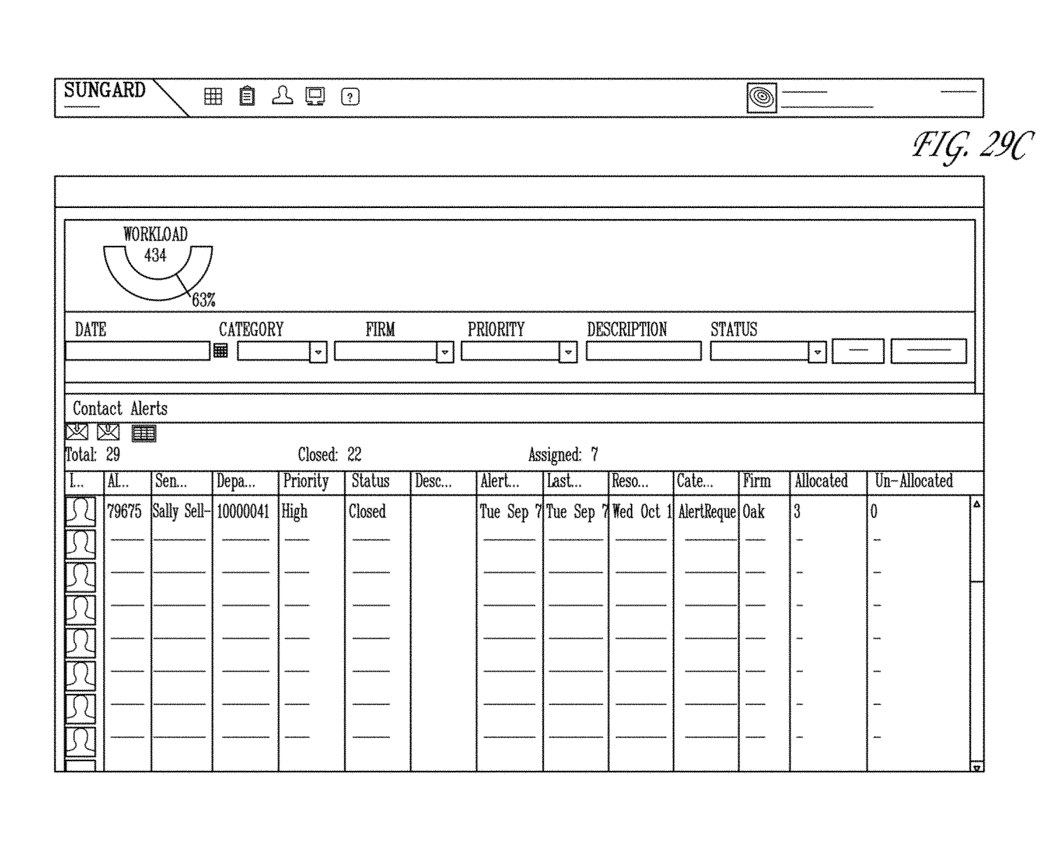

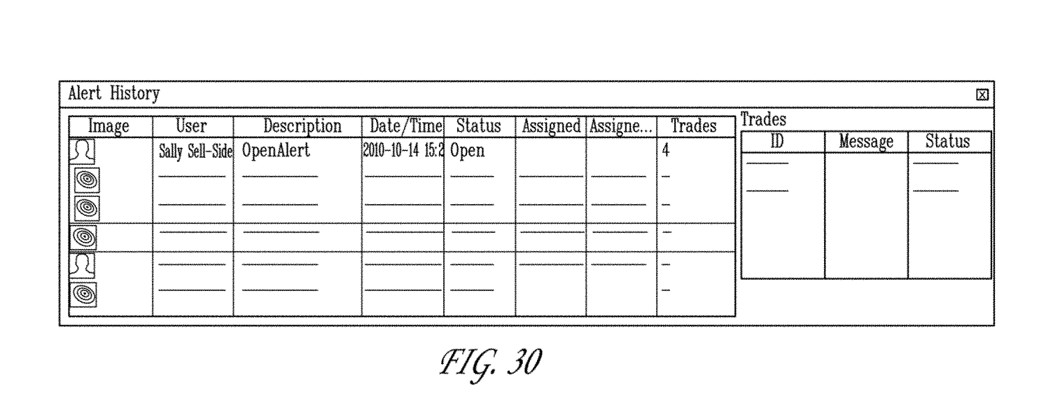

The panel allows access to historical data and audit trails of an alert, access to alerts from previous days, and offers the opportunity to drill down into the status and actions surrounding an alert as exemplified in FIG. 30. From a single view, the user can understand all actions surrounding and alert including, for example, when the alerts were performed, who performed the alerts, and what the current status of the alert and all underlying subject records is at a given point in time. The left portion of the history grid identifies all activities performed against the alert itself and the underlying subject records. The right hand side of the grid displays the status of the subject records. The example references an allocation request scenario. However, the pattern between alert and subject record is consistent across all types of data elements. All activity against an alert and its underlying subject records are accessible from anywhere in the trade processing system. A complete audit of all interaction with the data is retained.

FIG. 31 illustrates an example dashboard summary of the buy side firm that was designated to receive the alert in the scenario described in FIG. 29A. In the upper corner of the screen, an alert pops up to notify the operator that an alert has been sent. In an illustrative embodiment, the operator of the buy side firm dashboard may select to see an expanded view of the alert by clicking on the alert.

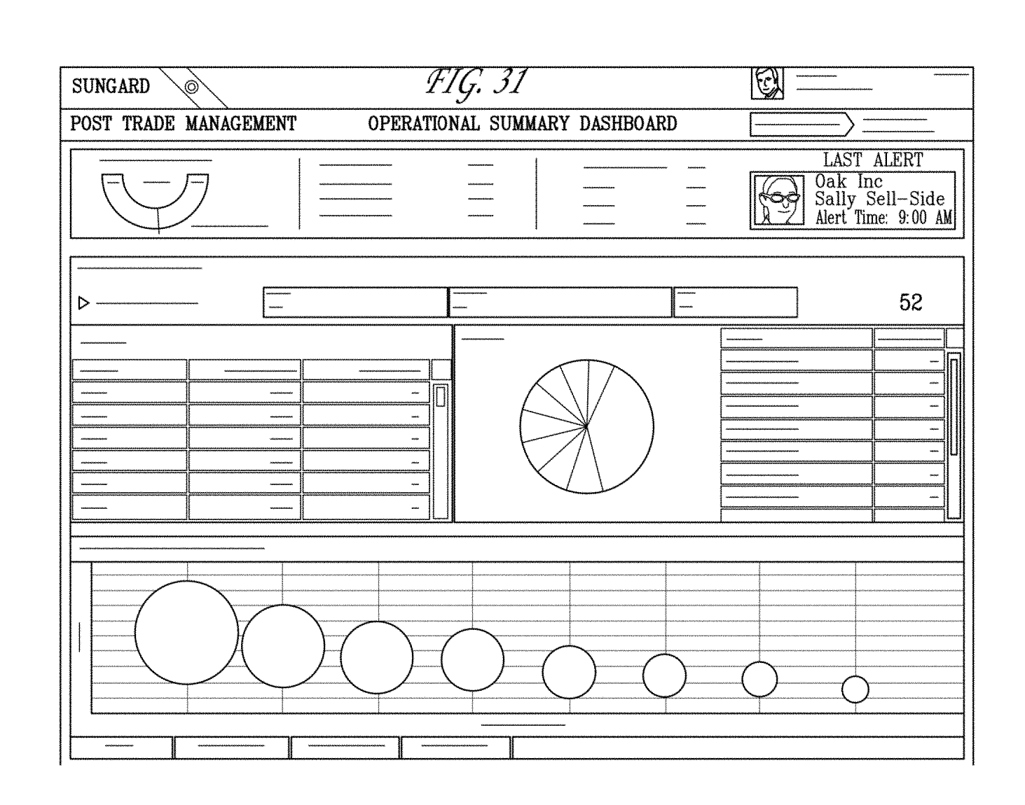

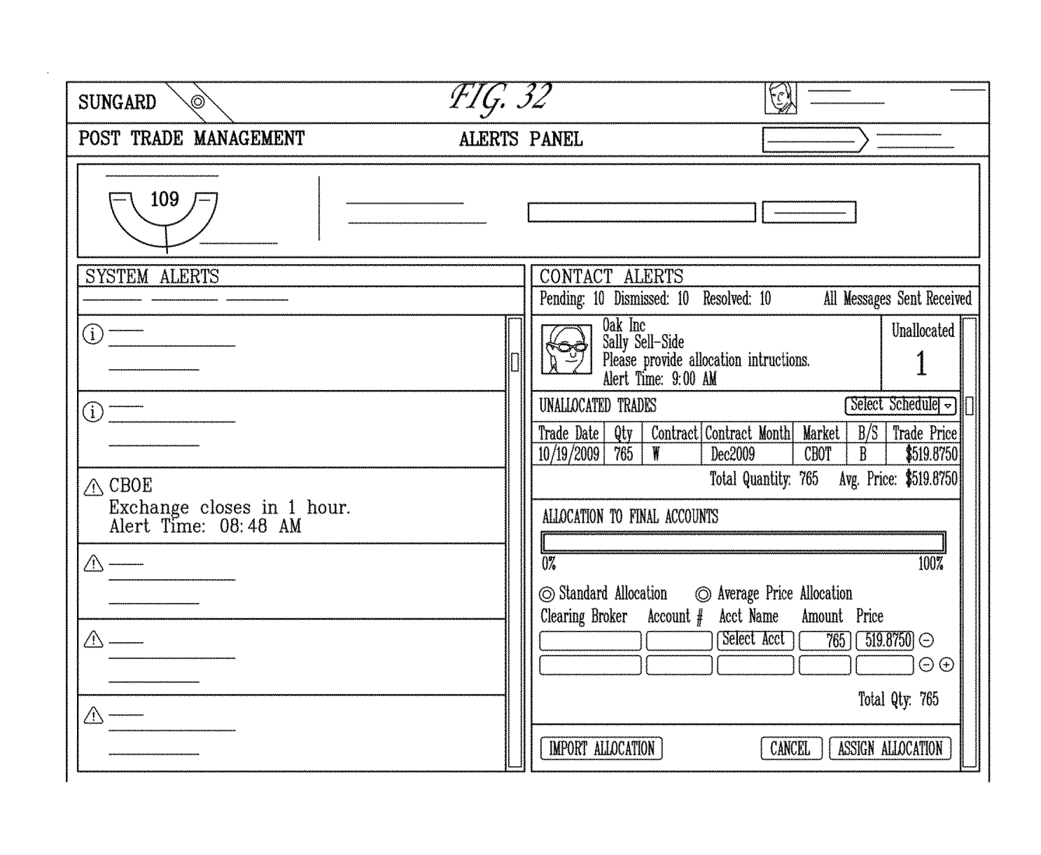

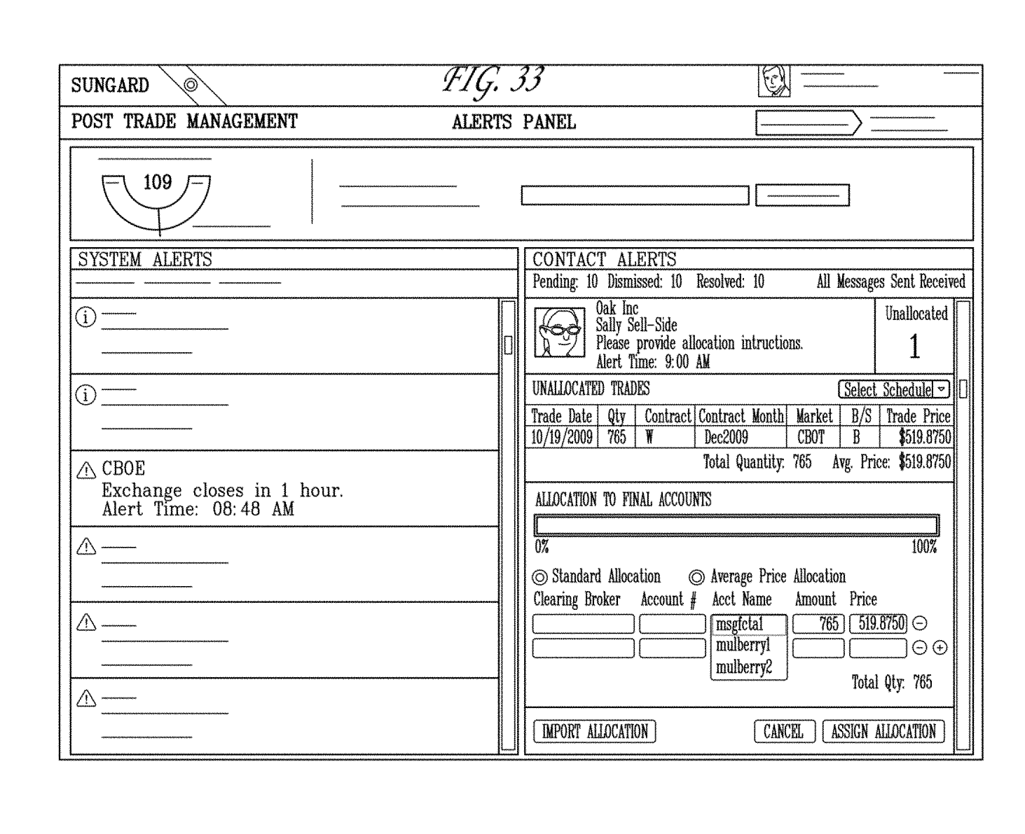

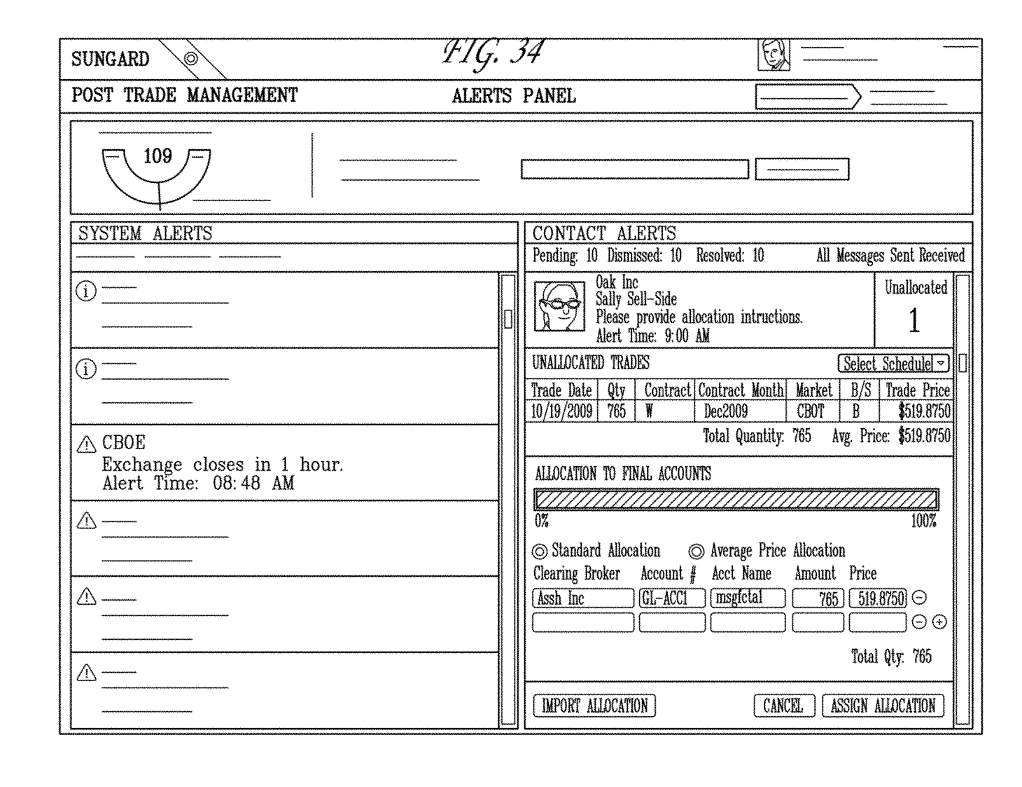

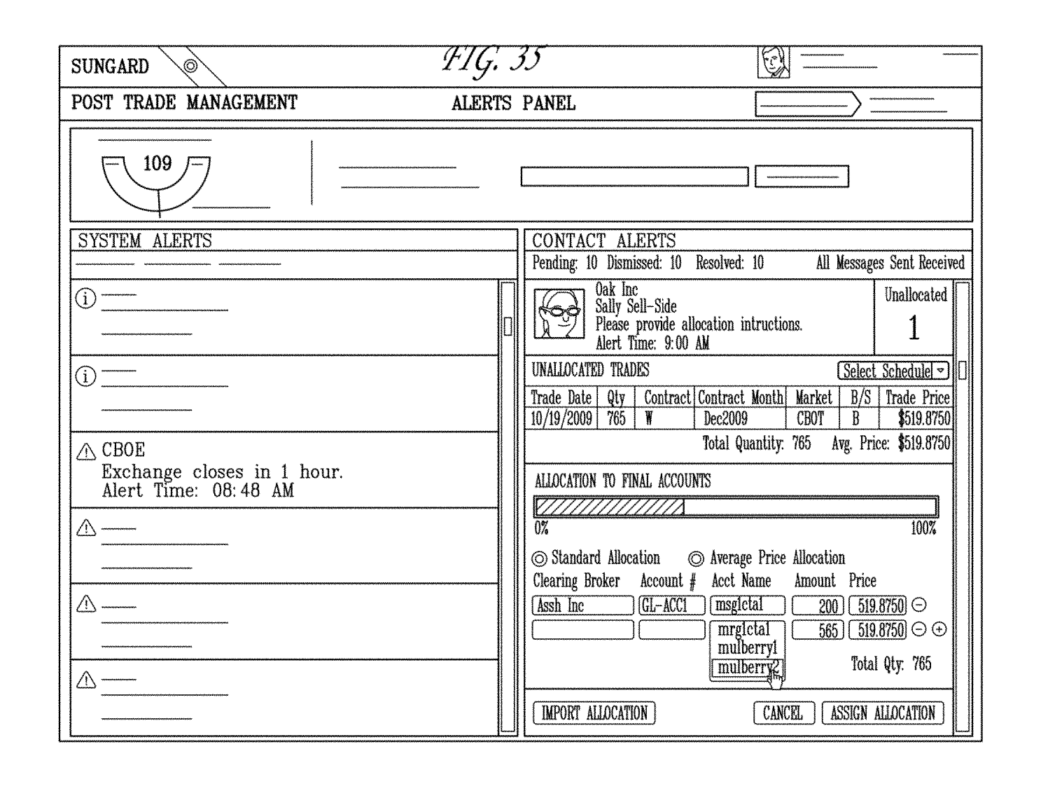

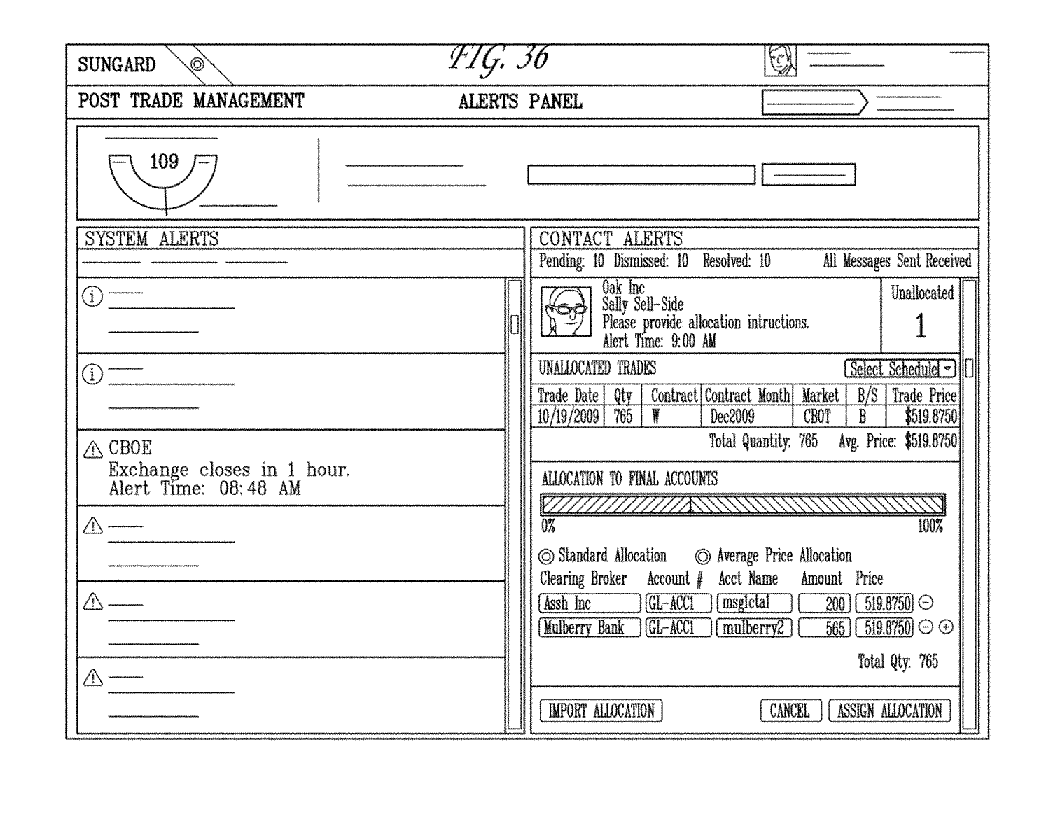

FIG. 32 provides an exemplary alerts panel screen with which the buy side firm may respond to the allocation alert. As shown, the allocation information is blank for the particular trade that is listed in the alert. In an exemplary scenario, the buy side operator may select an account to which the trade is to be designated. For example, and as depicted in FIG. 33, the operator may employ a drop down list to select an account. As depicted in FIG. 34, the corresponding information for the account may automatically populate. The operator may, of course, edit the allocation information manually as illustrated in FIG. 35. After completing the allocation information, the buy side firm operator may select to assign the allocation as depicted in FIG. 36.

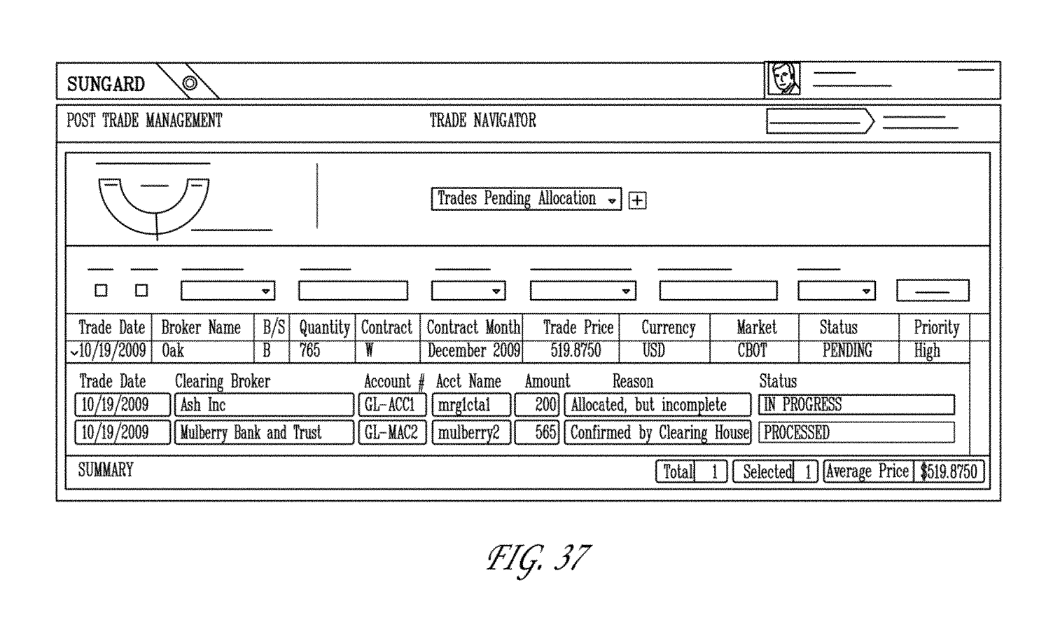

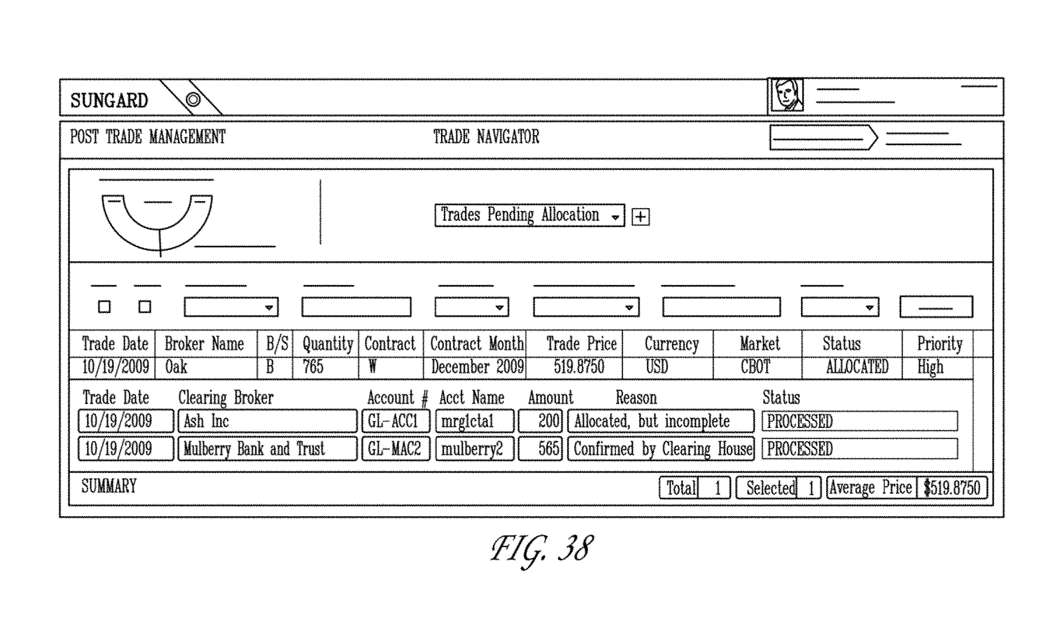

In response to the selection to assign the allocation, the buy side firm operator is returned to the alert panel. The operator can view the status of the alert and associated trade records from within the alert panel history as illustrated in FIG. 30 or navigate to the trade navigator screen as illustrated in FIG. 37. As illustrated, the allocation that was designated for the particular trade appears under the corresponding trade in the listing of trades pending allocation. As described above, the status of the allocation is shown in the navigator listing. And as illustrated in FIG. 38, when the allocation has completed, this status is illustrated in the navigator listing.

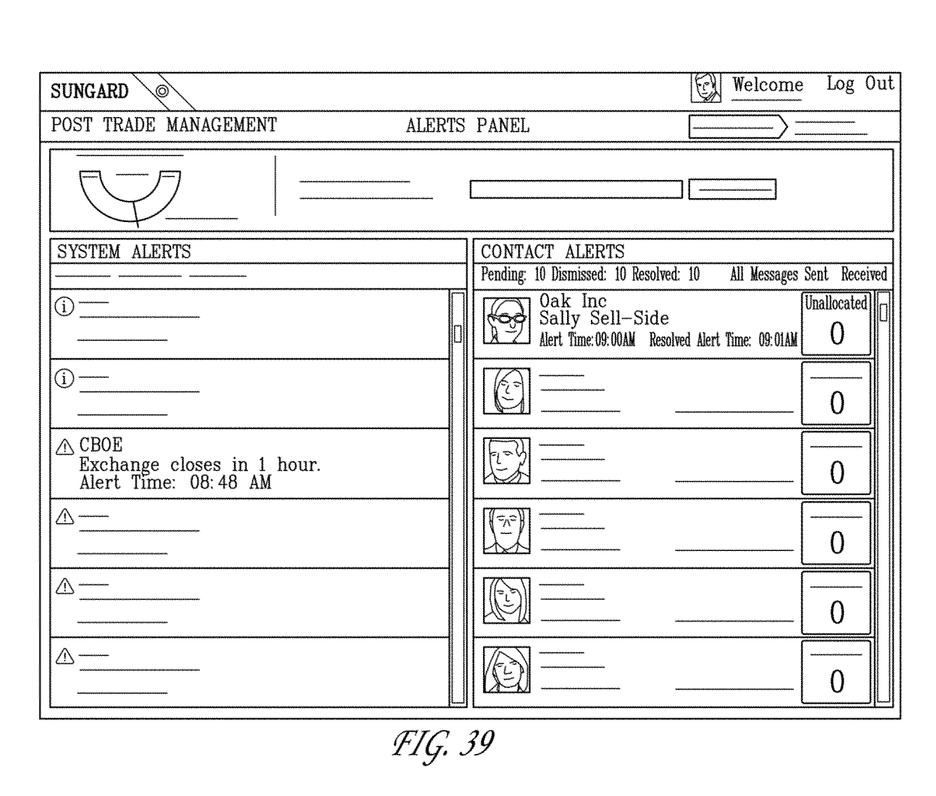

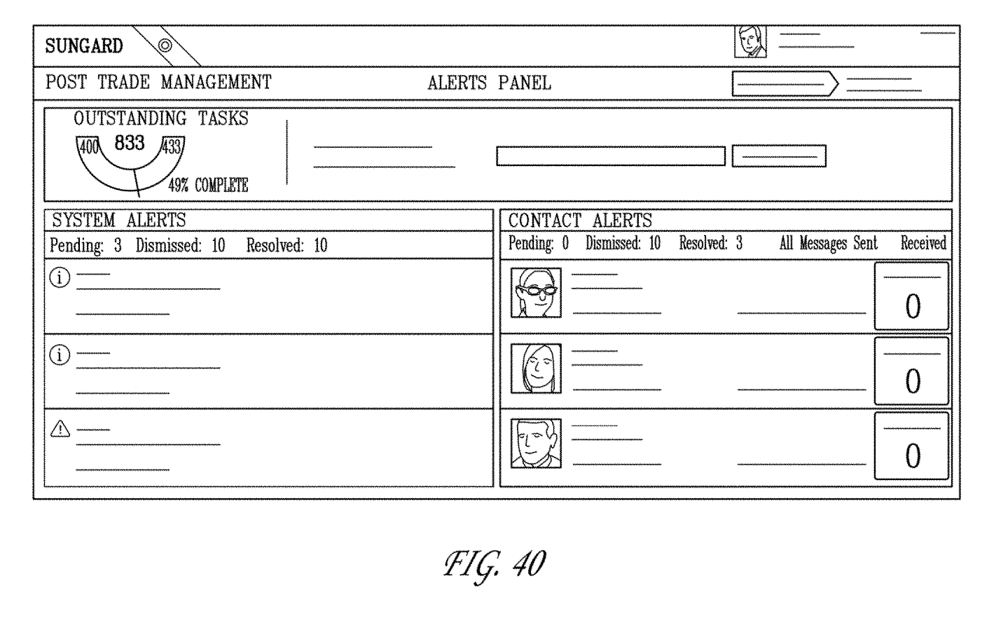

FIG. 39 provides a view of alerts panel for the buyer side operator. As shown in the listing of contact alerts, the alert corresponding to the request to allocate the particular trade shows a status indicating it has been completed. Similarly, and as depicted in FIG. 40, the sell side firm's alerts panel reflects that the alert that was created by the sell side firm has now been resolved.

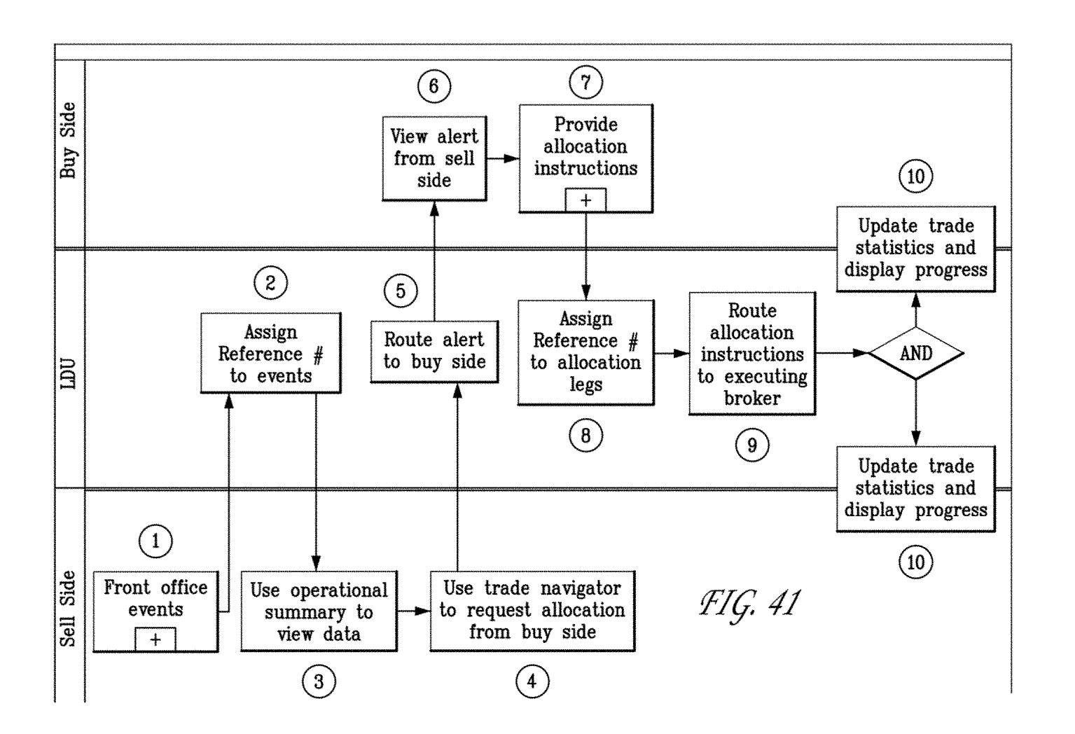

FIG. 41 provides a chart illustrating an exemplary flow of processing in trade processing system 130 for a sell side initiated alert for buy-side allocation. As illustrated at step 1, several front office events occur before trades are received into the system. These events include the buy-side placement of the trade order with the sell-side firm. The sell-side firm receives fills from the exchanges that execute those trades and then clears the trades with the appropriate clearing house. The trade enters the system in a cleared status and pending allocation. At step 2, the system assigns a reference number to the cleared trades.

At step 3, the sell-side user, upon logging into the system, reviews the operational summary dashboard to gain an understanding of the volume and priority of the cleared trades. At step 4, the sell-side user opens the trade navigator user interface whereby access is provided to the allocation status of pending trades. The user must select a particular trade and initiate a user-generated alert indicating that the buy-side user must process an allocation. At step 5, the system routes the sell-side user-generated alert to the buy-side user.

At step 6, the buy-side user is prompted by the system that an alert has been received from the sell-side user. The buy-side user reviews that alert and can choose to ignore it. In this case the alert is placed in the alert queue. Or the buy-side user can choose to take action on the alert, or the buy-side user can choose to dismiss the alert.

At step 7, the buy-side user chooses the method of allocation. In this example, the user selects a pre-defined allocation schedule. The user validates the schedule by reviewing the data on the allocation screen. The user has an ability to make adjustments to the allocation based on interaction with the system. The user submits the final allocation instruction to the system for trade processing.

At step 8, the system assigns reference numbers to each allocation leg. An allocation leg is a portion of the trade quantity that is assigned to a brokerage account. Since a single trade may be allocated to many accounts, it is necessary for the system to maintain a reference number for each allocation leg. The system also associates the allocation leg reference numbers with the trade reference numbers assigned in Step 2 above.

At step 9, the system routes the allocation instructions to the sell-side firm that cleared the trade and is waiting for the buy-side allocation. Once the allocation is received by the sell-side firm it can be further processed in the back-office systems of the sell-side firm. In an exemplary embodiment, give-up allocation instructions are directed to the clearing house. At step 10, the system updates the trade statistics on both the operational summary dashboard and trade navigator user interfaces of the buy-side firm and the sell-side firm.

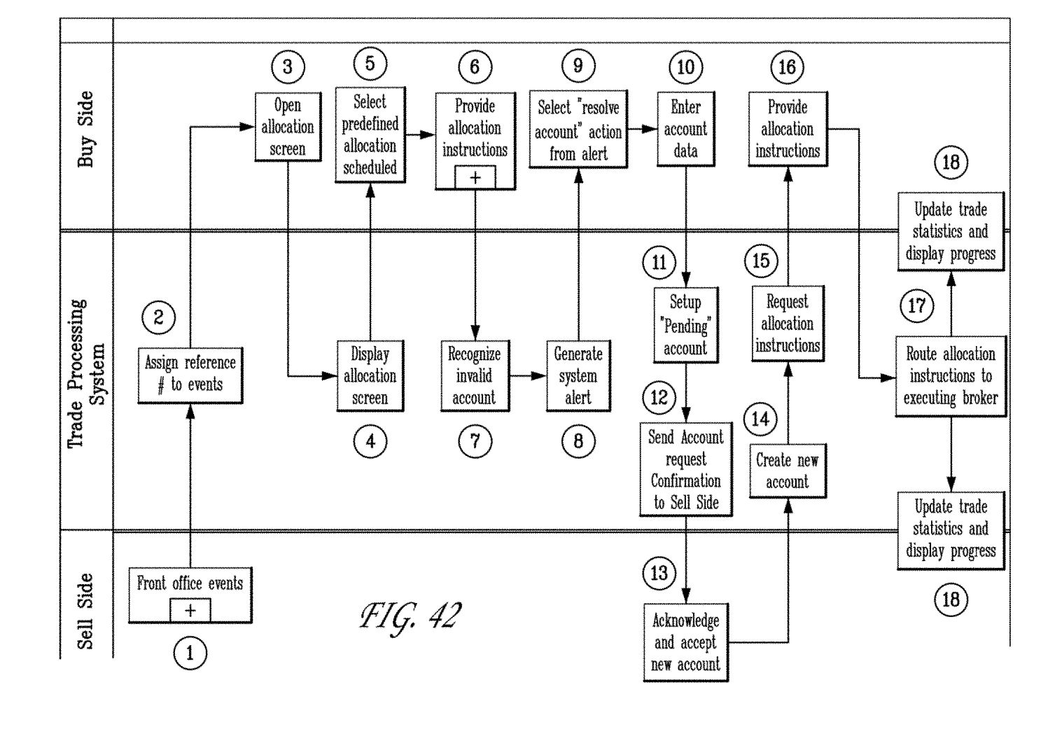

FIG. 42 provides a chart illustrating an exemplary flow of processing in trade processing system 130 for a buy side allocation wherein an exception is enforced by the system. As shown, at step 1, several front office events occur before trades are received into the system. These events include the buy-side placement of the trade order with the sell-side firm. The sell-side firm receives fills from the exchanges that execute those trades and then clears the trades with the appropriate clearing house. The trade enters the system in a cleared status and pending allocation. At step 2, the system assigns a reference number to the cleared trades.

At step 3, the buy-side user, upon logging into the system, reviews the operational summary dashboard user interface to gain an understanding of the volume and priority of the cleared trades. At step 4, the buy-side user opens the trade navigator user interface whereby access is provided to the allocation screen. The user must select a particular trade or group of trades and initiate a call to the system indicating the need to process an allocation.

At step 5, the system calls the trade database to identify the necessary trade data and displays that data on the allocation screen. At step 6, the buy-side user chooses the method of allocation. In this example, the user selects a pre-defined allocation schedule. The user validates the schedule by reviewing the data on the allocation screen. The user has an ability to make adjustments to the allocation based on interaction with the system. The user submits the final allocation instruction to the system for trade processing.

At step 7, the system recognizes the allocation instruction includes an invalid account. At step 8, the system generates an alert to the buy-side user indicating that an invalid account has been used in the allocation instruction.

At step 9, the buy-side user is prompted by the system that an alert has been received. The buy-side user reviews that alert and can choose to ignore it. In this case the alert is placed in the alert queue until the alert is either assigned, dismissed, or acted upon. In an exemplary embodiment, the buy side takes action to resolve the invalid account.

At step 10, the buy-side user enters valid account information into the account set-up and management screen. At step 11, the system modifies, or sets-up, the account information and flags the account in a pending status. At step 12, the system sends an alert to the sell-side user requesting confirmation on the pending account. The newly created, or modified, account information is provided to sell-side user.

At step 13, the sell-side user reviews the pending account information. The user can accept or reject the new account information. If accepted, the user submits the request for the system to complete the account set-up. At step 14, the system finalizes the creation of the account with the new, or modified, information.

At step 15, the system alerts the buy-side user that account has been accepted by the sell-side user. The system then alerts the buy-side user that the rejected allocation remains in a pending status.

At step 16, the buy-side user chooses the method of allocation. In this example, the user selects a pre-defined allocation schedule. The user validates the schedule by reviewing the data on the allocation screen. The user has an ability to make adjustments to the allocation based on interaction with the system. The user submits the final allocation instruction to the system for trade processing.

At step 17, the system assigns reference numbers to each allocation leg. The system routes the allocation instructions to the sell-side firm that cleared the trade and is waiting for the buy-side allocation instructions. Once the allocation is received by the sell-side firm it can be further processed in the back-office systems of the sell-side firm.

At step 18, the system updates the trade statistics on both the operational summary dashboard and trade navigator user interfaces at both the buy-side and sell side firm.

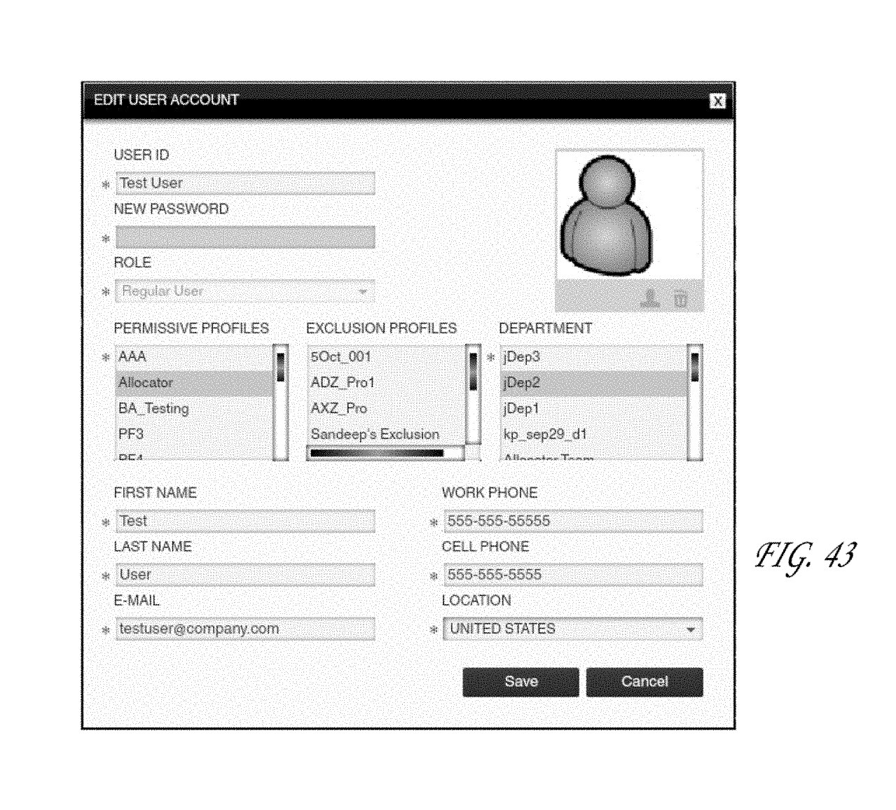

In connection with performing the various functionality described herein, trade processing system 130 relies upon the underlying data relating to users, firms, accounts, trades, alerts, rules, etc. Trade processing system 130 is adapted to maintain information for users, firms, accounts, trades, alerts, rules etc., and to use that information in performing the functions described herein. FIG. 43 depicts an exemplary screen that may be used to enter and modify information regarding a person that has an account with system 130. As shown, in an illustrative embodiment, the system may maintain contact information such as, for example, emails and phone numbers, for users as well as information specifying permissions that the user may have within the system. Such a screen may be accessed to create new users and to edit information relating to existing users. Analogous screens may be used to enter and maintain information regarding accounts and firms that are associated with the system.

In an exemplary embodiment, trade processing system 130 may be adapted to integrate data received into the system with relevant third party systems. For example, where trading account information is created in trade processing system 130, the account information may correspond to a trading account for a beneficial owner that exists with a third party brokerage. Trade processing system 130 is adapted to integrate information such as, for example, account information into external systems associated with third party firms. Indeed, trade processing system 130 may operate as a single point of data entry for external systems. Data such as account data may be entered first into the trade processing system 130 and then communicated out to third party systems that are in some manner associated with the account. For example, brokerage account information may be entered into trade processing system 130 and then the information communicated to the systems of the actual brokerage.

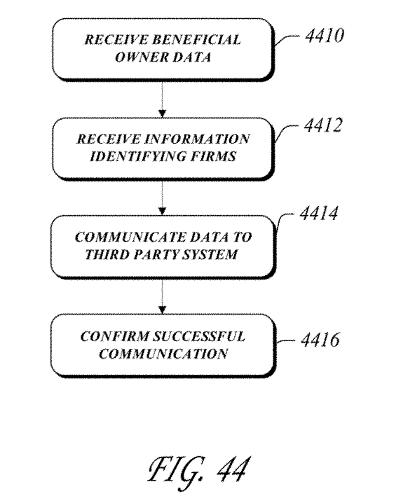

FIG. 44 depicts a flow chart of a process for integration of data. In the example depicted in FIG. 44, account data is being integrated; however other data types might also be integrated from the trade processing system 130 into third party systems. As shown at step 4410, trade processing system 130 receives data corresponding to a beneficial owner of an account. For example trade processing system 130 may receive contact information for the owner of a trading account, a mutual fund account, and/or a trust account. The information may be received using a screen analogous to that depicted in FIG. 43. As shown at step 4412, trade processing system 130 receives data identifying a plurality of firms associated with the account. For example, data may be received identifying one or more of a buy side firm, a sell side firm, and clearing house that is associated with the account. The information may comprise information about the account itself such as, for example, an account number, the name of a third party firm and or group within the firm that is responsible for the account, as well as any other administrative information. The data is stored in a database such as database 132. At step 4414, trade processing system 130 communicates the received data corresponding to a beneficial owner to external systems associated with the identified plurality of firms associated with the account. In an exemplary embodiment, the data is communicated electronically between trade processing system 130 and third party systems corresponding to the identified third party firms. At step 4416, trade processing system 130 confirms the successful communication of the data corresponding to the beneficial owner of a derivative trade account to the one or more third party systems. For example, trade processing system 130 may confirm that the communication of data is complete. Trade processing system 130 may also receive information back from a third party system and compare the received information to that which was communicated to the third party system.

Illustrative Computing Environment

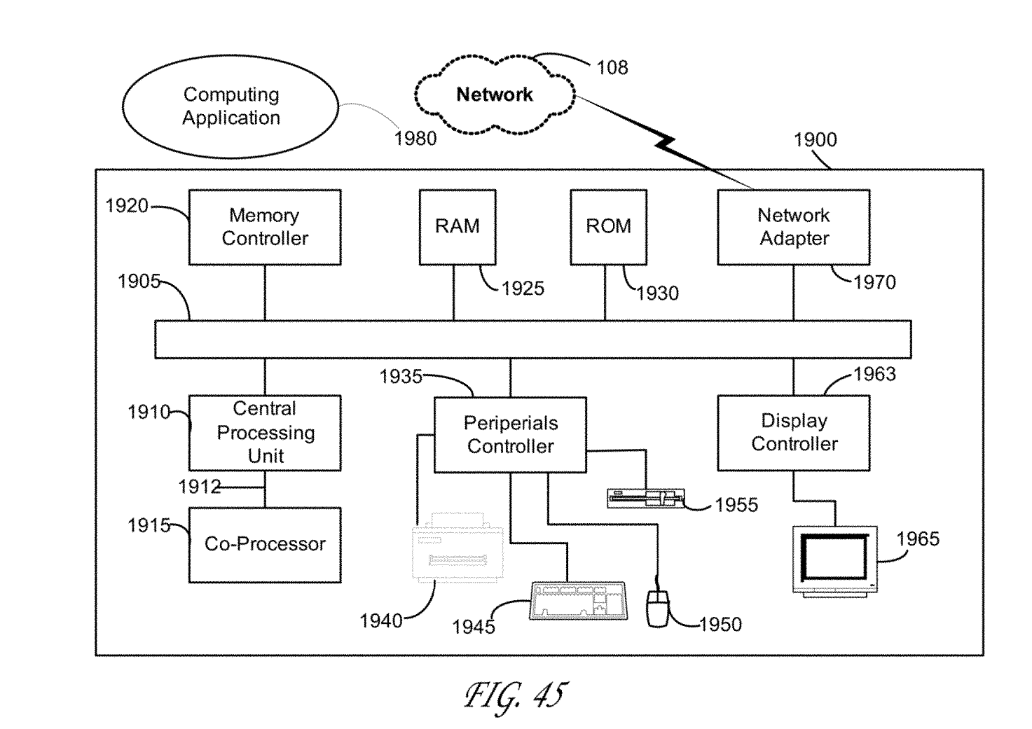

FIG. 45 depicts a block diagram of an exemplary computing system 1900 that may be used to implement the systems and methods described herein. For example, the computing system 1900 may be used to implement the trade processing system 130, described above, as well as the sell side system 110 and buy side system 120, or the like. The computing system 1900 may be capable of executing a variety of computing applications 1980. The computing applications 1980 may include a computing application, a computing applet, a computing program and other instruction set operative on the computing system 1900 to perform at least one function, operation, and/or procedure. The computing system 1900 may be controlled primarily by computer readable instructions that may be in the form of software. The computer readable instructions may include instructions for the computing system 1900 for storing and accessing the computer readable instructions themselves. Such software may be executed within a central processing unit (CPU) 1910 to cause the computing system 1900 to perform the processes or functions associated therewith. In many known computer servers, workstations, personal computers, or the like, the CPU 1910 may be implemented by micro-electronic chips CPUs called microprocessors.

In operation, the CPU 1910 may fetch, decode, and/or execute instructions and may transfer information to and from other resources via a main data-transfer path or a system bus 1905. Such a system bus may connect the components in the computing system 1900 and may define the medium for data exchange. The computing system 1900 may further include memory devices coupled to the system bus 1905. According to an example embodiment, the memory devices may include a random access memory (RAM) 1925 and read only memory (ROM) 1930. The RAM 1925 and ROM 1930 may include circuitry that allows information to be stored and retrieved. In one embodiment, the ROM 1930 may include stored data that cannot be modified. Additionally, data stored in the RAM 1925 typically may be read or changed by CPU 1910 or other hardware devices. Access to the RAM 1925 and/or ROM 1930 may be controlled by a memory controller 1920. The memory controller 1920 may provide an address translation function that translates virtual addresses into physical addresses as instructions are executed.

In addition, the computing system 1900 may include a peripherals controller 1935 that may be responsible for communicating instructions from the CPU 1910 to peripherals, such as, a printer 1940, a keyboard 1945, a mouse 1950, and data a storage drive 1955. The computing system 1900 may further include a display 1965 that may be controlled by a display controller 1963. The display 1965 may be used to display visual output generated by the computing system 1900. Such visual output may include text, graphics, animated graphics, video, or the like. The display controller 1963 may include electronic components that generate a video signal that may be sent to the display 1965. Further, the computing system 1900 may include a network adaptor 1970 that may be used to connect the computing system 1900 to an external communication network such as the network 108, described above in FIG. 1.

Thus, a system for derivative trade processing has been disclosed. The disclosed systems and methods are applicable to listed as well as unlisted derivatives. In a disclosed embodiment, the system aggregates data relating to trades across a plurality of buy side and sell side firms. The system is adapted to receive requests from buy side and sell side firms to search its aggregated data. In response to such request, the system provides a listing of trade data for trades with a plurality of counter-parties to the firm that made the search request. The requestor may view all trades and associated tasks across all counter-parties. The requestor may view the trades and tasks in prioritized lists. The system is adapted to respond to requests to allocate trades across multiple accounts.

The disclosed trade processing system aggregates data and thereby ensures that both buy side and sell side entities are looking at the same trade data. Moreover, the disclosed system allows buy side firms to allocate and take other post trade actions directly from the disclosed system. This system consolidates data from exchanges and member firms and relies upon various component engines, a workflow management service, and new communication functionality. A state of the art web user interface, customized to tasks of the user, provides an interface by which users may access the system. Using the disclosed system, sell side firms are able to view all of their trades, sort them by their own prioritization rules, and highlight certain trades to route to the buy side firm for allocation. Buy side firms may also view all of their cleared trades based on equally customizable prioritization rules, and sort, filter, and analyze based on their own criteria. Further, buy side users can manage requests from their sell side firms, increasing their customer satisfaction and increasing their performance measures. Buy side firms may allocate cleared trades directly; negating the need to copy instructions from one system into another. Unlike e-mail, telephone, FTP, and faxes, the disclosed system provides single point archiving, interfaces between the alert and the corresponding trade activities, and the ability to then report based on communications and actions. The workflow communications of the disclosed system are specific to allocations, rather than free from instant messaging, and consist of trade data, instructions, and information about the user sending the request. In an exemplary embodiment, the disclosed systems can also push alerts to a user's mobile device, allowing today's more mobile workforce greater flexibility to respond to changing business needs.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that —in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-44. (canceled)

45. A computer system, comprising:
a memory device storing instructions; and
one or more hardware processors coupled with the memory that execute the instructions to perform operations comprising:
receiving, via a computer network, trade order data from one or more remote buy side firm computer systems associated with one or more independent buy-side parties, the trade order data relating to executed derivative trade orders made by the one or more buy side firm systems;
receiving, via the computer network, trade fill data from one or more remote sell side firm computer systems associated with one or more independent sell-side parties, the trade fill data relating to executed derivative trade fills made by the one or more sell side firm systems;
aggregating, automatically by one or more of the hardware processors, the received trade order data with the received trade fill data in a database of aggregated data;
determining, by one or more of the hardware processors based on analyzing the aggregated data, that one or more trades of one of the buy side firms have not been assigned to an account;
assigning, automatically by one or more of the hardware processors, to a first sell side firm a task associated with each of the trades without an assigned account;
prioritizing, by one or more of the hardware processors, the task according to a closing of an exchange associated with the trade associated with each task; and
providing, by one or more of the hardware processors via the network, the prioritized tasks to one or more user devices of the first sell side firm via a web interface to display the prioritized tasks.

46. The computer system of claim 45, wherein the aggregating further comprises:
matching the received trade order data with the received trade fill data based on a trading number.

47. The computer system of claim 45, wherein the operations further comprise:
storing the received trade order data and the received trade fill data; and
providing an application programming interface (API) for remote systems to request the stored trade order data and trade fill data.

48. The computer system of claim 45, wherein the operations further comprise:
determining one or more accounts to allocate the unassigned one or more trades; and
generating allocation instructions to allocate the one or more trades to the determined one or more accounts.

49. The computer system of claim 48, wherein the operations further comprise:
automatically executing the allocation instructions to allocate the one or more trades to the determined one or more accounts.

50. The computer system of claim 48, wherein the operations further comprise:
requesting an input via the web interface to execute the allocation instructions or modify the generated allocation instructions.

51. The computer system of claim 45, wherein the operations further comprise:
generating, by the one or more hardware processors, an alert to the first sell side firm indicating the task has been assigned to the first sell side firm.

52. A method, performed by one or more hardware processors, comprising:
receiving, via a computer network, trade order data from one or more remote buy side firm computer systems associated with one or more independent buy-side parties;
receiving, via the computer network, trade fill data from one or more remote sell side firm computer systems associated with one or more independent sell-side parties;
aggregating, automatically by one or more of the hardware processors, the received trade order data with the received trade fill data in a database of aggregated data;
determining, by one or more of the hardware processors based on analyzing the aggregated data, that one or more trades of one of the buy side firms have not been assigned to an account;
assigning, automatically by one or more of the hardware processors, to a first sell side firm a task associated with each of the trades without an assigned account;
prioritizing, by one or more of the hardware processors, the task according to a closing of an exchange associated with the trade associated with each task; and
providing, by one or more of the hardware processors via the network, the prioritized tasks to one or more user devices of the first sell side firm via a web interface to display the prioritized tasks.

53. The method of claim 52, wherein the aggregating further comprises:
matching the received trade order data with the received trade fill data based on a trading number.

54. The method of claim 52, further comprising:
storing the received trade order data and the received trade fill data; and
providing an application programming interface (API) for remote systems to request the stored trade order data and trade fill data.

55. The method of claim 52, further comprising:
determining one or more accounts to allocate the unassigned one or more trades; and
generating allocation instructions to allocate the one or more trades to the determined one or more accounts.

56. The method of claim 55, further comprising:
automatically executing the allocation instructions to allocate the one or more trades to the determined one or more accounts.

57. The method of claim 55, further comprising:
requesting an input via the web interface to execute the allocation instructions or modify the generated allocation instructions.

58. The method of claim 52, further comprising:
generating, by the one or more hardware processors, an alert to the first sell side firm indicating the task has been assigned to the first sell side firm.

59. A computer-readable medium, comprising instructions for one or more hardware processors to perform operations comprising:
receiving, via a computer network, trade order data from one or more remote buy side firm computer systems associated with one or more independent buy-side parties, the trade order data relating to executed derivative trade orders made by the one or more buy side firm systems;
receiving, via the computer network, trade fill data from one or more remote sell side firm computer systems associated with one or more independent sell-side parties, the trade fill data relating to executed derivative trade fills made by the one or more sell side firm systems;
aggregating, automatically by one or more of the hardware processors, the received trade order data with the received trade fill data in a database of aggregated data;
determining, by one or more of the hardware processors based on analyzing the aggregated data, that one or more trades of one of the buy side firms have not been assigned to an account;
assigning, automatically by one or more of the hardware processors, to a first sell side firm a task associated with each of the trades without an assigned account;
prioritizing, by one or more of the hardware processors, the task according to a closing of an exchange associated with the trade associated with each task; and
providing, by one or more of the hardware processors via the network, the prioritized tasks to one or more user devices of the first sell side firm via a web interface to display the prioritized tasks.

60. The computer-readable medium of claim 59, wherein the aggregating further comprises:
matching the received trade order data with the received trade fill data based on a trading number.

61. The computer-readable medium of claim 59, wherein the operations further comprise:
storing the received trade order data and the received trade fill data; and
providing an application programming interface (API) for remove systems to request the stored trade order data and trade fill data.

62. The computer-readable medium of claim 59, wherein the operations further comprise:
determining one or more accounts to allocate the unassigned one or more trades; and
generating allocation instructions to allocate the one or more trades to the determined one or more accounts.

63. The computer-readable medium of claim 59, wherein the operations further comprise:
automatically executing the allocation instructions to allocate the one or more trades to the determined one or more accounts.

64. The computer-readable medium of claim 59, wherein the operations further comprise:
generating, by the one or more hardware processors, an alert to the first sell side firm indicating the task has been assigned to the first sell side firm.
